(19) United States
(12) Patent Application Publication
(10) Pub. No.: US 2016/0258602 A1
(43) Pub. Date: Sep. 8, 2016

(54) LOW-PROFILE LIGHTING SYSTEM HAVING PIVOTABLE LIGHTING ENCLOSURE

(71) Applicant: EcoSense Lighting Inc., Los Angeles, CA (US)

(72) Inventors: Paul Pickard, Acton, CA (US); Robert Fletcher, Pasadena, CA (US); Edward R Adams, Englewood, TN (US)

(21) Appl. No.: 14/636,205

(22) Filed: Mar. 3, 2015

(51) Int. Cl. F21V 19/02; F21V 21/30; F21V 13/04; F21V 23/02; F21K 99/00; F21V 7/00

(52) U.S. Cl. CPC F21V 19/02; F21K 9/30; F21V 7/0083; F21V 13/04; F21V 23/023; F21V 21/30

(57) ABSTRACT

Lighting system including first and second enclosures, and pivotable joint assembly. First enclosure is elongated along first longitudinal axis and configured for mounting array of plurality of lighting modules; and includes: two opposing end panels spaced apart along first axis; first and second spaced-apart pairs of opposing elongated side panels; and four elongated enclosure edges joining together first and second pairs of side panels. Second enclosure is elongated along second longitudinal axis and configured for containing lighting module power supply; and includes: two opposing end panels spaced apart along second axis; third and fourth spaced-apart pairs of opposing elongated side panels; and four elongated enclosure edges joining together third and fourth pairs of side panels. Pivotable joint assembly has pivotable joint axis parallel with first and second axes; is interposed between edges; and configured for constraining movement of first and second axes as around and parallel with pivotable joint axis.

### BACKGROUND OF THE INVENTION

1. Field of the Invention

The present invention relates to the field of lighting systems that include semiconductor light-emitting devices.

2. Background of the Invention

Numerous lighting systems that include semiconductor light-emitting devices have been developed. As examples, some of such lighting systems may include an elongated housing for an array of a plurality of lighting modules. Despite the existence of these lighting systems, further improvements are still needed in lighting systems that include semiconductor light-emitting devices.

### SUMMARY

In an example of an implementation, a lighting system is provided that includes: a first enclosure; a second enclosure; and a pivotable joint assembly. The first enclosure is elongated along a first longitudinal axis and is configured for mounting an array of a plurality of lighting modules. The first enclosure includes: two opposing end panels being spaced apart along the first longitudinal axis; a first spaced-apart pair of opposing elongated side panels; a second spaced-apart pair of opposing elongated side panels; and four elongated enclosure edges joining together the first and second pairs of the elongated side panels along the first longitudinal axis. The second enclosure is elongated along a second longitudinal axis and is configured for containing a lighting module power supply. The second enclosure includes: two additional opposing end panels being spaced apart along the second longitudinal axis; a third spaced-apart pair of opposing elongated side panels; a fourth spaced-apart pair of opposing elongated side panels; and four additional elongated enclosure edges joining together the third and fourth pairs of the elongated side panels along the second longitudinal axis. The pivotable joint assembly has a pivotable joint axis; and the pivotable joint axis is parallel with the first and second longitudinal axes. The pivotable joint assembly is interposed between a one of the elongated enclosure edges and a one of the additional elongated enclosure edges. The pivotable joint assembly is configured for constraining movement of the first longitudinal axis relative to the second longitudinal axis as being around and parallel with the pivotable joint axis.

In some examples of the lighting system, the pivotable joint assembly may be configured for permitting a one of the first spaced-apart pair of elongated side panels to face towards a one of the third spaced-apart pair of elongated side panels.

In further examples of the lighting system, the pivotable joint assembly may be configured for permitting a one of the second spaced-apart pair of elongated side panels to face towards a one of the fourth spaced-apart pair of elongated side panels.

In additional examples of the lighting system, configuring the pivotable joint assembly for permitting the one of the second spaced-apart pair of elongated side panels to face towards the one of the fourth spaced-apart pair of elongated side panels may include configuring the pivotable joint assembly for permitting the one of the first spaced-apart pair of elongated side panels to be rotated away from the one of the third spaced-apart pair of elongated side panels around the pivotable joint axis by an angle being within a range of between about 0 degrees and about 180 degrees.

In other examples of the lighting system, the one of the first spaced-apart pair of elongated side panels may include a first panel region having a generally flat profile, and the one of the third spaced-apart pair of elongated side panels may include a third panel region having a generally flat profile, and the pivotable joint assembly may be configured for permitting the one of the first spaced-apart pair of elongated side panels to be in direct contact with the one of the third spaced-apart pair of elongated side panels.

In some examples of the lighting system, the first panel region may have first dimensions including a first length along the first longitudinal axis, and a first width; and the third panel region may have third dimensions including a third length along the second longitudinal axis, and a third width; and the first width may be substantially the same as the third width.

In further examples of the lighting system, another one of the first spaced-apart pair of elongated side panels may include another first panel region having a generally flat profile, and another one of the third spaced-apart pair of elongated side panels may include another third panel region having a generally flat profile.

In additional examples of the lighting system, a one of the second spaced-apart pair of elongated side panels may include a second panel region having a generally flat profile, and a one of the fourth spaced-apart pair of elongated side panels may include a fourth panel region having a generally flat profile, and the pivotable joint assembly may be configured for permitting the one of the second spaced-apart pair of elongated side panels to be in direct contact with the one of the fourth spaced-apart pair of elongated side panels.

In other examples of the lighting system, the second panel region may have second dimensions including a second length along the first longitudinal axis, and a second width; and the fourth panel region may have fourth dimensions including a fourth length along the second longitudinal axis, and a fourth width; and the second width may be smaller than the fourth width.

In some examples of the lighting system, a combined width being a sum of the second and fourth widths of the lighting system may be within a range of between about 35 millimeters and about 50 millimeters.

In further examples of the lighting system, another one of the second spaced-apart pair of elongated side panels may include another second panel region having a generally flat profile, and another one of the fourth spaced-apart pair of elongated side panels may include another fourth panel region having a generally flat profile.

In additional examples of the lighting system, configuring the pivotable joint assembly for permitting the one of the second spaced-apart pair of elongated side panels to be in direct contact with the one of the fourth spaced-apart pair of elongated side panels may include configuring the pivotable joint assembly for permitting the one of the second spaced-apart pair of elongated side panels to be rotated toward the one of the fourth spaced-apart pair of elongated side panels around the pivotable joint axis by an angle being within a range of between about 0 degrees and about 180 degrees.

In other examples of the lighting system, the one of the third spaced-apart pair of elongated side panels may include a third panel region having a generally flat profile, and the second enclosure may be configured for mounting the lighting system by placing the one of the third spaced-apart pair of elongated side panels in contact with a support.

In some examples of the lighting system, another one of the third spaced-apart pair of elongated side panels may include another third panel region having a generally flat profile, and the second enclosure may be configured for mounting the lighting system by placing the another one of the third spaced-apart pair of elongated side panels in contact with a support.

In further examples of the lighting system, a one of the fourth spaced-apart pair of elongated side panels may include a fourth panel region having a generally flat profile, and the second enclosure may be configured for mounting the lighting system by placing the one of the fourth spaced-apart pair of elongated side panels in contact with a support.

In additional examples of the lighting system, a one of the first spaced-apart pair of elongated side panels may include a first panel region having a generally flat profile having first dimensions including a first length along the first longitudinal axis, and a first width; and a one of the second spaced-apart pair of elongated side panels may include a second panel region having a generally flat profile having second dimensions including a second length along the first longitudinal axis, and a second width; and the second width may be substantially smaller than the first width.

In other examples of the lighting system, a one of the third spaced-apart pair of elongated side panels may include a third panel region having a generally flat profile having third dimensions including a third length along the second longitudinal axis, and a third width; and a one of the fourth spaced-apart pair of elongated side panels may include a fourth panel region having a generally flat profile having fourth dimensions including a fourth length along the second longitudinal axis, and a fourth width; and the fourth width may be substantially smaller than the second width.

In some examples, the lighting system may further have an array of a plurality of lighting modules being mounted in the first enclosure, the pivotable joint assembly may be configured for permitting a one of the first spaced-apart pair of elongated side panels to face towards a one of the third spaced-apart pair of elongated side panels, and the first enclosure may be configured for mounting the array of the plurality of lighting modules for emitting light emissions through another one of the first spaced-apart pair of elongated side panels.

In further examples of the lighting system, the another one of the first spaced-apart pair of elongated side panels may include a first transparent panel region having a generally flat profile.

In additional examples of the lighting system, each one of the plurality of the lighting modules may include a semiconductor light-emitting device.

In other examples of the lighting system, each one of the plurality of the lighting modules may have a central light emission axis, and each one of the plurality of the lighting modules may be configured for emitting light emissions along the central light emission axis of the lighting module.

In some examples of the lighting system, the first enclosure may include a primary visible light reflector having a plurality of reflector apertures, the plurality of the reflector apertures being spaced apart along the first longitudinal axis and being aligned with the central light emission axes of the lighting modules.

In further examples of the lighting system, the primary visible light reflector may include the plurality of the reflector apertures as being spaced apart in a row along the first longitudinal axis.

In additional examples of the lighting system, the primary visible light reflector may include the plurality of the reflector apertures as being spaced apart in a plurality of rows along the first longitudinal axis.

In other examples of the lighting system, the primary visible light reflector may include a plurality of reflector elements, and each of the reflector elements may include a top reflective surface being located between two tangential reflective surfaces, and each of the reflector apertures of the primary visible light reflector may be located between a pair of the reflector elements.

In some examples of the lighting system, the first enclosure may further include a carrier having a plurality of carrier apertures, the plurality of the carrier apertures being spaced apart along the first longitudinal axis and being aligned with the central light emission axes of the lighting modules, each one of the plurality of the carrier apertures of the carrier being configured and shaped for receiving and mounting a lens module.

In further examples, the lighting system may further include an array of a plurality of lighting modules being mounted in the first enclosure, the pivotable joint assembly may be configured for permitting a one of the first spaced-apart pair of elongated side panels to face towards a one of the third spaced-apart pair of elongated side panels, and the first enclosure may be configured for mounting the array of the plurality of lighting modules for emitting light emissions through a one of the second spaced-apart pair of elongated side panels.

In other examples of the lighting system, the pivotable joint assembly may include a first pivot joint element being attached to the first enclosure and a second pivot joint element being attached to the second enclosure, and the first and second pivot joint elements may be configured for cooperatively securing the one of the first spaced-apart pair of elongated side panels at a position being located away from the one of the third spaced-apart pair of elongated side panels around the pivotable joint axis by an angle being within the range of between about 0 degrees and about 180 degrees.

In some examples of the lighting system, the pivotable joint assembly may include a first pivot joint element being attached to the first enclosure and a second pivot joint element being attached to the second enclosure, and the first and second pivot joint elements may be configured for cooperatively securing the one of the first spaced-apart pair of elongated side panels at a position being located away from the one of the third spaced-apart pair of elongated side panels by an angle around the pivotable joint axis.

In further examples of the lighting system, the first pivot joint element may include a first circular disc having a first flat side with raised features, and the second pivot joint element may include a second circular disc having a second flat side with raised features, and the pivotable joint assembly may be configured for placing the first flat side of the first circular disc in direct contact with the second flat side of the second circular disc.

In other examples of the lighting system, the raised features of the first and second flat sides of the first and second circular discs may each include a circular pattern of alternating radially extending crests and valleys having a uniform contour.

In some examples of the lighting system, the pivotable joint assembly may include a spring being configured for biasing the first flat side of the first circular disc as being in direct contact with the second flat side of the second circular disc.

In further examples of the lighting system, the first pivot joint element may include a first circular clutch plate, and the second pivot joint element may include a second circular clutch plate, and the pivotable joint assembly may be configured for placing the first clutch plate in direct contact with the second clutch plate.

In additional examples of the lighting system, the first clutch plate may include a first frictional pad, and the second clutch plate may include a second frictional pad, and the pivotable joint assembly may be configured for placing the first frictional pad in direct contact with the second frictional pad.

In other examples, the lighting system may include another pivotable joint assembly that may include a third pivot joint element being attached to the first enclosure and a fourth pivot joint element being attached to the second enclosure, and the third and fourth pivot joint elements may be configured for cooperatively securing the one of the first spaced-apart pair of elongated side panels at a position being located away from the one of the third spaced-apart pair of elongated side panels around the pivotable joint axis by an angle within the range of between about 0 degrees and about 180 degrees.

In some examples, the lighting system may include another pivotable joint assembly that may include a third pivot joint element being attached to the first enclosure and a fourth pivot joint element being attached to the second enclosure, and the third and fourth pivot joint elements may be configured for cooperatively securing the one of the first spaced-apart pair of elongated side panels at a position being located away from the one of the third spaced-apart pair of elongated side panels by an angle around the pivotable joint axis.

In further examples of the lighting system, the third pivot joint element may include a third circular disc having a third flat side with raised features, and the fourth pivot joint element may include a fourth circular disc having a fourth flat side with raised features, and the another pivotable joint assembly may be configured for placing the third flat side of the third circular disc in direct contact with the fourth flat side of the fourth circular disc.

In additional examples of the lighting system, the raised features of the third and fourth flat sides of the third and fourth circular discs may each include a circular pattern of alternating radially extending crests and valleys having a uniform contour.

In other examples of the lighting system, the another pivotable joint assembly may include another spring being configured for biasing the third flat side of the third circular disc as being in direct contact with the fourth flat side of the fourth circular disc.

In some examples of the lighting system, the second pivot joint element may be attached to one of the end panels of the second enclosure, and the fourth pivot joint element may be attached to another one of the end panels of the second enclosure.

In further examples of the lighting system, each of the first and third pivot joint elements may be attached to the one of the first spaced-apart pair of elongated side panels.

In additional examples of the lighting system, the one of the first spaced-apart pair of elongated side panels may include: a support plate attached to the pivotable joint assembly; and another support plate attached to the another pivotable joint assembly.

In other examples of the lighting system, each of the support plates may include a raised rib being spaced apart from a raised lip, being configured for attaching the support plates to the one of the first spaced-apart pair of elongated side panels; and the one of the first spaced-apart pair of elongated side panels may include two spaced-apart tracks configured for receiving the raised ribs and the raised lips.

In some examples of the lighting system, each of the pivot joint elements may include a raised rib being spaced apart from a raised lip, being configured for attaching the pivot joint elements to the one of the first spaced-apart pair of elongated side panels.

In further examples of the lighting system, the second enclosure may be configured for mounting the lighting system by placing a one of the third spaced-apart pair of elongated side panels in contact with a support.

In additional examples of the lighting system, the second enclosure may include a mounting hole in the one of the third spaced-apart pair of elongated side panels, and the mounting hole may be adapted for receiving a screw or nail for placing the second enclosure in contact with a support.

In further examples of the lighting system, the second enclosure may include a plurality of mounting holes in the one of the third spaced-apart pair of elongated side panels, and each of the mounting holes may be adapted for receiving a screw or nail for placing the second enclosure in contact with a support.

Other systems, processes, features and advantages of the invention will be or will become apparent to one with skill in the art upon examination of the following figures and detailed description. It is intended that all such additional systems, processes, features and advantages be included within this description, be within the scope of the invention, and be protected by the accompanying claims.

### BRIEF DESCRIPTION OF THE FIGURES

The invention can be better understood with reference to the following figures. The components in the figures are not necessarily to scale, emphasis instead being placed upon illustrating the principles of the invention. Moreover, in the figures, like reference numerals designate corresponding parts throughout the different views.

FIG. 1 is a perspective view showing an example [100] of an implementation of a lighting system.

FIG. 2 is another perspective view showing the example [100] of an implementation of a lighting system.

FIG. 3 is a side view taken along the line 3-3, showing the example [100] of the lighting system.

FIG. 4 is another side view of the example [100] of the lighting system shown in FIG. 3.

FIG. 5 is another perspective view showing the example [100] of an implementation of a lighting system.

FIG. 6 is a top view showing examples of the carrier and the primary visible light reflector that may be included in the example [100] of an implementation of a lighting system.

FIG. 7 is a perspective view showing the examples of the carrier and the primary visible light reflector as shown in FIG. 6.

FIG. 8 is a cross-sectional view taken on line 8-8, of the example [100] of the lighting system as shown in FIG. 5.

FIG. 9 is a perspective view showing a portion of an example [100] of the lighting system.

FIG. 10 is another perspective view showing a portion of an example [100] of the lighting system.

FIG. 11 is a further perspective view showing a portion of an example [100] of the lighting system.

FIG. 12 is an additional perspective view showing a portion of an example [100] of the lighting system.

FIG. 13 is another perspective view showing a portion of an example [100] of the lighting system.

FIG. 14 is another perspective view showing a portion of an example [100] of the lighting system.

### DETAILED DESCRIPTION

Various lighting systems that utilize semiconductor light-emitting devices have been designed. Many such lighting systems exist that may include an array of lighting modules. However, existing lighting systems often provide limited flexibility for mounting the lighting systems, and fail to enable the orientations for the light emissions to be easily and repeatedly selected and changed from among a wide range of options.

Lighting systems accordingly are provided herein, that include: a first enclosure; a second enclosure; and a pivotable joint assembly. The first enclosure is elongated along a first longitudinal axis and is configured for mounting an array of a plurality of lighting modules. The first enclosure includes: two opposing end panels being spaced apart along the first longitudinal axis; a first spaced-apart pair of opposing elongated side panels; a second spaced-apart pair of opposing elongated side panels; and four elongated enclosure edges joining together the first and second pairs of the elongated side panels along the first longitudinal axis. The second enclosure is elongated along a second longitudinal axis and is configured for containing a lighting module power supply. The second enclosure includes: two additional opposing end panels being spaced apart along the second longitudinal axis; a third spaced-apart pair of opposing elongated side panels; a fourth spaced-apart pair of opposing elongated side panels; and four additional elongated enclosure edges joining together the third and fourth pairs of the elongated side panels along the second longitudinal axis. The pivotable joint assembly has a pivotable joint axis; and the pivotable joint axis is parallel with the first and second longitudinal axes. The pivotable joint assembly is interposed between a one of the elongated enclosure edges and a one of the additional elongated enclosure edges. The pivotable joint assembly is configured for constraining movement of the first longitudinal axis relative to the second longitudinal axis as being around and parallel with the pivotable joint axis.

The following definitions of terms, being stated as applying “throughout this specification”, are hereby deemed to be incorporated throughout this specification, including but not limited to the Summary, Brief Description of the Figures, Detailed Description, and Claims.

Throughout this specification, the term “semiconductor” means: a substance, examples including a solid chemical element or compound, that can conduct electricity under some conditions but not others, making the substance a good medium for the control of electrical current.

Throughout this specification, the term “semiconductor light-emitting device” (also being abbreviated as “SLED”) means: a light-emitting diode; an organic light-emitting diode; a laser diode; or any other light-emitting device having one or more layers containing inorganic and/or organic semiconductor(s). Throughout this specification, the term “light-emitting diode” (herein also referred to as an “LED”) means: a two-lead semiconductor light source having an active pn-junction. As examples, an LED may include a series of semiconductor layers that may be epitaxially grown on a substrate such as, for example, a substrate that includes sapphire, silicon, silicon carbide, gallium nitride or gallium arsenide. Further, for example, one or more semiconductor p-n junctions may be formed in these epitaxial layers. When a sufficient voltage is applied across the p-n junction, for example, electrons in the n-type semiconductor layers and holes in the p-type semiconductor layers may flow toward the p-n junction. As the electrons and holes flow toward each other, some of the electrons may recombine with corresponding holes, and emit photons. The energy release is called electroluminescence, and the color of the light, which corresponds to the energy of the photons, is determined by the energy band gap of the semiconductor. As examples, a spectral power distribution of the light generated by an LED may generally depend on the particular semiconductor materials used and on the structure of the thin epitaxial layers that make up the “active panel region” of the device, being the area where the light is generated. As examples, an LED may have a light-emissive electroluminescent layer including an inorganic semiconductor, such as a Group III-V semiconductor, examples including: gallium nitride; silicon; silicon carbide; and zinc oxide. Throughout this specification, the term “organic light-emitting diode” (herein also referred to as an “OLED”) means: an LED having a light-emissive electroluminescent layer including an organic semiconductor, such as small organic molecules or an organic polymer. It is understood throughout this specification that a semiconductor light-emitting device may include: a non-semiconductor-substrate or a semiconductor-substrate; and may include one or more electrically-conductive contact layers. Further, it is understood throughout this specification that an LED may include a substrate formed of materials such as, for example: silicon carbide; sapphire; gallium nitride; or silicon. It is additionally understood throughout this specification that a semiconductor light-emitting device may have a cathode contact on one side and an anode contact on an opposite side, or may alternatively have both contacts on the same side of the device.

Further background information regarding semiconductor light-emitting devices is provided in the following documents, the entireties of all of which hereby are incorporated by reference herein: U.S. Pat. Nos. 7,564,180; 7,456,499; 7,213,940; 7,095,056; 6,958,497; 6,853,010; 6,791,119; 6,600,175; 6,201,262; 6,187,606; 6,120,600; 5,912,477; 5,739,554; 5,631,190; 5,604,135; 5,523,589; 5,416,342; 5,393,993; 5,359,345; 5,338,944; 5,210,051; 5,027,168; 5,027,168; 4,966,862; and 4,918,497; and U.S. Patent Application Publication Nos. 2014/0225511; 2014/0078715; 2013/0241392; 2009/0184616; 2009/0080185; 2009/0050908; 2009/0050907; 2008/0308825; 2008/0198112; 2008/0179611; 2008/0173884; 2008/0121921; 2008/0012036; 2007/0253209; 2007/0223219; 2007/0170447; 2007/0158668; 2007/0139923; and 2006/0221272.

Throughout this specification, the term “spectral power distribution” means: the emission spectrum of the one or more wavelengths of light emitted by a semiconductor light-emitting device. Throughout this specification, the term “peak wavelength” means: the wavelength where the spectral power distribution of a semiconductor light-emitting device reaches its maximum value as detected by a photo-detector. As an example, an LED may be a source of nearly monochromatic light and may appear to emit light having a single color. Thus, the spectral power distribution of the light emitted by such an LED may be centered about its peak wavelength. As examples, the “width” of the spectral power distribution of an LED may be within a range of between about 10 nanometers and about 30 nanometers, where the width is measured at half the maximum illumination on each side of the emission spectrum. Throughout this specification, the term “full-width-half-maximum” (“FWHM”) means: the full width of the spectral power distribution of a semiconductor light-emitting device measured at half the maximum illumination on each side of its emission spectrum. Throughout this specification, the term “half-width-half-maximum” (“HWHM”) means: half of the full width of a FWHM. Throughout this specification, the term “dominant wavelength” means: the wavelength of monochromatic light that has the same apparent color as the light emitted by a semiconductor light-emitting device, as perceived by the human eye. As an example, since the human eye perceives yellow and green light better than red and blue light, and because the light emitted by a semiconductor light-emitting device may extend across a range of wavelengths, the color perceived (i.e., the dominant wavelength) may differ from the peak wavelength.

Throughout this specification, the term “luminous flux”, also referred to as “luminous power”, means: the measure in lumens of the perceived power of light, being adjusted to reflect the varying sensitivity of the human eye to different wavelengths of light. Throughout this specification, the term “radiant flux” means: the measure of the total power of electromagnetic radiation without being so adjusted. Throughout this specification, the term “central light emission axis” means a direction along which the light emissions of a semiconductor light-emitting device have a greatest radiant flux. It is understood throughout this specification that light emissions “along a central light emission axis” means light emissions that: include light emissions in the directions of the central light emission axis; and may further include light emissions in a plurality of other generally similar directions.

It is understood throughout this specification that the word “along” generally means “in directions that include the same directions as, and also in other directions being similar to”. It is understood throughout this specification that light emissions “along the longitudinal axis” means light emissions that: include light emissions in the directions of the longitudinal axis; and may further include light emissions in a plurality of other generally similar directions. It is understood throughout this specification that light emissions “in directions transverse to the longitudinal axis” means light emissions that: include light emissions in the directions being orthogonal to the longitudinal axis; and may further include light emissions in a plurality of other generally similar directions. It is understood throughout this specification that light emissions “in directions spaced apart from directions along the longitudinal axis” means light emissions in directions being similar to and spaced apart from the directions along the longitudinal axis. It is understood throughout this specification that light emissions “in directions spaced apart from directions transverse to the longitudinal axis” means light emissions in directions being similar to and spaced apart from the directions being transverse to the longitudinal axis.

Throughout this specification, the term “luminescent” means: characterized by absorption of electromagnetic radiation (e.g., visible light, UV light or infrared light) causing the emission of light by, as examples: fluorescence; and phosphorescence.

Throughout this specification, the term “object” means a material article or device. Throughout this specification, the term “surface” means an exterior boundary of an object. Throughout this specification, the term “incident visible light” means visible light that propagates in one or more directions towards a surface. Throughout this specification, the term “reflective surface” means a surface of an object that causes incident visible light, upon reaching the surface, to then propagate in one or more different directions away from the surface without passing through the object. Throughout this specification, the term “planar reflective surface” means a generally flat reflective surface.

Throughout this specification, the term “reflectance” means a fraction of a radiant flux of incident visible light having a specified wavelength that is caused by a reflective surface of an object to propagate in one or more different directions away from the surface without passing through the object. Throughout this specification, the term “reflected light” means the incident visible light that is caused by a reflective surface to propagate in one or more different directions away from the surface without passing through the object. Throughout this specification, the term “Lambertian reflectance” means diffuse reflectance of visible light from a surface, in which the reflected light has uniform radiant flux in all of the propagation directions. Throughout this specification, the term “specular reflectance” means mirror-like reflection of visible light from a surface, in which light from a single incident direction is reflected into a single propagation direction. Throughout this specification, the term “spectrum of reflectance values” means a spectrum of values of fractions of radiant flux of incident visible light, the values corresponding to a spectrum of wavelength values of visible light, that are caused by a reflective surface to propagate in one or more different directions away from the surface without passing through the object. Throughout this specification, the term “transmittance” means a fraction of a radiant flux of incident visible light having a specified wavelength that is permitted by a reflective surface to pass through the object having the reflective surface. Throughout this specification, the term “transmitted light” means the incident visible light that is permitted by a reflective surface to pass through the object having the reflective surface. Throughout this specification, the term “spectrum of transmittance values” means a spectrum of values of fractions of radiant flux of incident visible light, the values corresponding to a spectrum of wavelength values of visible light, that are permitted by a reflective surface to pass through the object having the reflective surface. Throughout this specification, the term “absorbance” means a fraction of a radiant flux of incident visible light having a specified wavelength that is permitted by a reflective surface to pass through the reflective surface and is absorbed by the object having the reflective surface. Throughout this specification, the term “spectrum of absorbance values” means a spectrum of values of fractions of radiant flux of incident visible light, the values corresponding to a spectrum of wavelength values of visible light, that are permitted by a reflective surface to pass through the reflective surface and are absorbed by the object having the reflective surface. Throughout this specification, it is understood that a reflective surface, or an object, may have a spectrum of reflectance values, and a spectrum of transmittance values, and a spectrum of absorbance values. The spectra of reflectance values, absorbance values, and transmittance values of a reflective surface or of an object may be measured, for example, utilizing an ultraviolet-visible-near infrared (UV-VIS-NIR) spectrophotometer. Throughout this specification, the term “visible light reflector” means an object having a reflective surface. In examples, a visible light reflector may be selected as having a reflective surface characterized by light reflections that are more Lambertian than specular.

Throughout this specification, the term “lumiphor” means: a medium that includes one or more luminescent materials being positioned to absorb light that is emitted at a first spectral power distribution by a semiconductor light-emitting device, and to re-emit light at a second spectral power distribution in the visible or ultra violet spectrum being different than the first spectral power distribution, regardless of the delay between absorption and re-emission. Lumiphors may be categorized as being down-converting, i.e., a material that converts photons to a lower energy level (longer wavelength); or up-converting, i.e., a material that converts photons to a higher energy level (shorter wavelength). As examples, a luminescent material may include: a phosphor; a quantum dot; a quantum wire; a quantum well; a photonic nanocrystal; a semiconducting nanoparticle; a scintillator; a lumiphoric ink; a lumiphoric organic dye; a day glow tape; a phosphorescent material; or a fluorescent material. Throughout this specification, the term “quantum material” means any luminescent material that includes: a quantum dot; a quantum wire; or a quantum well. Some quantum materials may absorb and emit light at spectral power distributions having narrow wavelength ranges, for example, wavelength ranges having spectral widths being within ranges of between about 25 nanometers and about 50 nanometers. In examples, two or more different quantum materials may be included in a lumiphor, such that each of the quantum materials may have a spectral power distribution for light emissions that may not overlap with a spectral power distribution for light absorption of any of the one or more other quantum materials. In these examples, cross-absorption of light emissions among the quantum materials of the lumiphor may be minimized. As examples, a lumiphor may include one or more layers or bodies that may contain one or more luminescent materials that each may be: (1) coated or sprayed directly onto an semiconductor light-emitting device; (2) coated or sprayed onto surfaces of a lens or other elements of packaging for an semiconductor light-emitting device; (3) dispersed in a matrix medium; or (4) included within a clear encapsulant (e.g., an epoxy-based or silicone-based curable resin or glass or ceramic) that may be positioned on or over an semiconductor light-emitting device. A lumiphor may include one or multiple types of luminescent materials. Other materials may also be included with a lumiphor such as, for example, fillers, diffusants, colorants, or other materials that may as examples improve the performance of or reduce the overall cost of the lumiphor. In examples where multiple types of luminescent materials may be included in a lumiphor, such materials may, as examples, be mixed together in a single layer or deposited sequentially in successive layers.

Throughout this specification, the term “volumetric lumiphor” means a lumiphor being distributed in an object having a shape including defined exterior surfaces. In some examples, a volumetric lumiphor may be formed by dispersing a lumiphor in a volume of a matrix medium having suitable spectra of visible light transmittance values and visible light absorbance values. As examples, such spectra may be affected by a thickness of the volume of the matrix medium, and by a concentration of the lumiphor being distributed in the volume of the matrix medium. In examples, the matrix medium may have a composition that includes polymers or oligomers of: a polycarbonate; a silicone; an acrylic; a glass; a polystyrene; or a polyester such as polyethylene terephthalate. Throughout this specification, the term “remotely-located lumiphor” means a lumiphor being spaced apart at a distance from and positioned to receive light that is emitted by a semiconductor light-emitting device.

Throughout this specification, the term “light-scattering particles” means small particles formed of a non-luminescent, non-wavelength-converting material. In some examples, a volumetric lumiphor may include light-scattering particles being dispersed in the volume of the matrix medium for causing some of the light emissions having the first spectral power distribution to be scattered within the volumetric lumiphor. As an example, causing some of the light emissions to be so scattered within the matrix medium may cause the luminescent materials in the volumetric lumiphor to absorb more of the light emissions having the first spectral power distribution. In examples, the light-scattering particles may include: rutile titanium dioxide; anatase titanium dioxide; barium sulfate; diamond; alumina; magnesium oxide; calcium titanate; barium titanate; strontium titanate; or barium strontium titanate. In examples, light-scattering particles may have particle sizes being within a range of about 0.01 micron (10 nanometers) and about 2.0 microns (2,000 nanometers).

In some examples, a visible light reflector may be formed by dispersing light-scattering particles having a first index of refraction in a volume of a matrix medium having a second index of refraction being suitably different from the first index of refraction for causing the volume of the matrix medium with the dispersed light-scattering particles to have suitable spectra of reflectance values, transmittance values, and absorbance values for functioning as a visible light reflector. As examples, such spectra may be affected by a thickness of the volume of the matrix medium, and by a concentration of the light-scattering particles being distributed in the volume of the matrix medium, and by physical characteristics of the light-scattering particles such as the particle sizes and shapes, and smoothness or roughness of exterior surfaces of the particles. In an example, the smaller the difference between the first and second indices of refraction, the more light-scattering particles may need to be dispersed in the volume of the matrix medium to achieve a given amount of light-scattering. As examples, the matrix medium for forming a visible light reflector may have a composition that includes polymers or oligomers of: a polycarbonate; a silicone; an acrylic; a glass; a polystyrene; or a polyester such as polyethylene terephthalate. In further examples, the light-scattering particles may include: rutile titanium dioxide; anatase titanium dioxide; barium sulfate; diamond; alumina; magnesium oxide; calcium titanate; barium titanate; strontium titanate; or barium strontium titanate. In other examples, a visible light reflector may include a reflective polymeric or metallized surface formed on a visible light-transmissive polymeric or metallic object such as, for example, a volume of a matrix medium. Additional examples of visible light reflectors may include microcellular foamed polyethylene terephthalate sheets (“MCPET”). Suitable visible light reflectors may be commercially available under the trade names White Optics® and MIRO® from WhiteOptics LLC, 243-G Quigley Blvd., New Castle, Del. 19720 USA. Suitable MCPET visible light reflectors may be commercially available from the Furukawa Electric Co., Ltd., Foamed Products Division, Tokyo, Japan. Additional suitable visible light reflectors may be commercially available from CVI Laser Optics, 200 Dorado Place SE, Albuquerque, N. Mex. 87123 USA.

In some examples, a converging or diverging lens may be formed as a volume of a matrix medium having a suitable shape for functioning as a lens. In further examples, forming a diverging lens may include dispersing light-scattering particles having a first index of refraction in a volume of a matrix medium having a second index of refraction being suitably different from the first index of refraction for causing the volume of the matrix medium with the dispersed light-scattering particles to have suitable light-scattering value for functioning as a diverging lens. As examples, the matrix medium for forming a lens may have a composition that includes polymers or oligomers of: a polycarbonate; a silicone; an acrylic; a glass; a polystyrene; or a polyester such as polyethylene terephthalate. In further examples, the light-scattering particles may include: rutile titanium dioxide; anatase titanium dioxide; barium sulfate; diamond; alumina; magnesium oxide; calcium titanate; barium titanate; strontium titanate; or barium strontium titanate.

In further examples, a volumetric lumiphor and a visible light reflector may be integrally formed. As examples, a volumetric lumiphor and a visible light reflector may be integrally formed in respective layers of a volume of a matrix medium, including a layer of the matrix medium having a dispersed lumiphor, and including another layer of the same or a different matrix medium having light-scattering particles being suitably dispersed for causing the another layer to have suitable spectra of reflectance values, transmittance values, and absorbance values for functioning as the visible light reflector. In other examples, an integrally-formed volumetric lumiphor and visible light reflector may incorporate any of the further examples of variations discussed above as to separately-formed volumetric lumiphors and visible light reflectors.

Throughout this specification, the term “phosphor” means: a material that exhibits luminescence when struck by photons. Examples of phosphors that may be utilized include: CaAlSiN₃:Eu, SrAlSiN₃:Eu, CaAlSiN₃:Eu, Ba₃Si₆O₁₂N₂:Eu, Ba₂SiO₄:Eu, Sr₂SiO₄:Eu, Ca₂SiO₄:Eu, Ca₃Sc₂Si₃O₁₂:Ce, Ca₃Mg₂Si₃O₁₂:Ce, CaSc₂O₄:Ce, CaSi₂O₂N₂:Eu, SrSi₂O₂N₂:Eu, BaSi₂O₂N₂:Eu, Ca₅(PO₄)₃Cl:Eu, Ba₅(PO₄)₃Cl:Eu, Cs₂CaP₂O₇, Cs₂SrP₂O₇, SrGa₂S₄:Eu, Lu₃Al₅O₁₂:Ce, Ca₈Mg(SiO₄)₄Cl₂:Eu, Sr₈Mg(SiO₄)₄Cl₂:Eu, La₃Si₆N₁:Ce, Y₃Al₅O₁₂:Ce, Y₃Ga₅O₁₂:Ce, Gd₃Al₅O₁₂:Ce, Gd₃Ga₅O₁₂:Ce, Tb₃Al₅O₁₂:Ce, Tb₃Ga₅O₁₂:Ce, Lu₃Ga₅O₁₂:Ce, (SrCa)AlSiN₃:Eu, LuAG:Ce, (Y,Gd)₂Al₅)₁₂:Ce, CaS:Eu, SrS:Eu, SrGa₂S₄:E₄, Ca₂(Sc,Mg)₂SiO₁₂:Ce, Ca₂Sc₂Si₂)₁₂:C2, Ca₂Sc₂O₄:Ce, Ba₂Si₆O₁₂N₂:Eu, (Sr,Ca)AlSiN₂:Eu, and CaAlSiN₂:Eu.

Throughout this specification, the term “quantum dot” means: a nanocrystal made of semiconductor materials that are small enough to exhibit quantum mechanical properties, such that its excitons are confined in all three spatial dimensions.

Throughout this specification, the term “quantum wire” means: an electrically conducting wire in which quantum effects influence the transport properties.

Throughout this specification, the term “quantum well” means: a thin layer that can confine (quasi-)particles (typically electrons or holes) in the dimension perpendicular to the layer surface, whereas the movement in the other dimensions is not restricted.

Throughout this specification, the term “photonic nanocrystal” means: a periodic optical nanostructure that affects the motion of photons, for one, two, or three dimensions, in much the same way that ionic lattices affect electrons in solids.

Throughout this specification, the term “semiconducting nanoparticle” means: a particle having a dimension within a range of between about 1 nanometer and about 100 nanometers, being formed of a semiconductor.

Throughout this specification, the term “scintillator” means: a material that fluoresces when struck by photons.

Throughout this specification, the term “lumiphoric ink” means: a liquid composition containing a luminescent material. For example, a lumiphoric ink composition may contain semiconductor nanoparticles. Examples of lumiphoric ink compositions that may be utilized are disclosed in Cao et al., U.S. Patent Application Publication No. 20130221489 published on Aug. 29, 2013, the entirety of which hereby is incorporated herein by reference.

Throughout this specification, the term “lumiphoric organic dye” means an organic dye having luminescent up-converting or down-converting activity. As au example, some perylene-based dyes may be suitable.

Throughout this specification, the term “day glow tape” means: a tape material containing a luminescent material.

Throughout this specification, the term “visible light” means light having one or more wavelengths being within a range of between about 380 nanometers and about 670 nanometers; and “visible light spectrum” means the range of wavelengths of between about 380 nanometers and about 670 nanometers.

Throughout this specification, the term “white light” means: light having a color point located at a delta(uv) of about equal to or less than 0.006 and having a CCT being within a range of between about 10000K and about 1800K (herein referred to as a “white color point.”). Many different hues of light may be perceived as being “white.” For example, some “white” light, such as light generated by a tungsten filament incandescent lighting device, may appear yellowish in color, while other “white” light, such as light generated by some fluorescent lighting devices, may appear more bluish in color. As examples, white light having a CCT of about 3000K may appear yellowish in color, while white light having a CCT of about equal to or greater than 8000K may appear more bluish in color and may be referred to as “cool” white light. Further, white light having a CCT of between about 2500K and about 4500K may appear reddish or yellowish in color and may be referred to as “warm” white light. “White light” includes light having a spectral power distribution of wavelengths including red, green and blue color points. In an example, a CCT of a lumiphor may be tuned by selecting one or more particular luminescent materials to be included in the lumiphor. For example, light emissions from a semiconductor light-emitting device that includes three separate emitters respectively having red, green and blue color points with an appropriate spectral power distribution may have a white color point. As another example, light perceived as being “white” may be produced by mixing light emissions from a semiconductor light-emitting device having a blue, greenish-blue or purplish-blue color point together with light emissions having a yellow color point being produced by passing some of the light emissions having the blue, greenish-blue or purplish-blue color point through a lumiphor to down-convert them into light emissions having the yellow color point. General background information on systems and processes for generating light perceived as being “white” is provided in “Class A Color Designation for Light Sources Used in General Illumination”, Freyssinier and Rea, J. Light & Vis. Env., Vol. 37, No. 2 & 3 (Nov. 7, 2013, Illuminating Engineering Institute of Japan), pp. 10-14; the entirety of which hereby is incorporated herein by reference.

Throughout this specification, the term “in contact with” means: that a first object, being “in contact with” a second object, is in either direct or indirect contact with the second object. Throughout this specification, the term “in indirect contact with” means: that the first object is not in direct contact with the second object, but instead that there are a plurality of objects (including the first and second objects), and each of the plurality of objects is in direct contact with at least one other of the plurality of objects (e.g., the first and second objects are in a stack and are separated by one or more intervening layers). Throughout this specification, the term “in direct contact with” means: that the first object, which is “in direct contact” with a second object, is touching the second object and there are no intervening objects between at least portions of both the first and second objects.

Throughout this specification, the term “spectrophotometer” means: an apparatus that can measure a light beam's intensity as a function of its wavelength and calculate its total luminous flux.

Throughout this specification, the term “integrating sphere-spectrophotometer” means: a spectrophotometer operationally connected with an integrating sphere. An integrating sphere (also known as an Ulbricht sphere) is an optical component having a hollow spherical cavity with its interior covered with a diffuse white reflective coating, with small holes for entrance and exit ports. Its relevant property is a uniform scattering or diffusing effect. Light rays incident on any point on the inner surface are, by multiple scattering reflections, distributed equally to all other points. The effects of the original direction of light are minimized. An integrating sphere may be thought of as a diffuser which preserves power but destroys spatial information. Another type of integrating sphere that can be utilized is referred to as a focusing or Coblentz sphere. A Coblentz sphere has a mirror-like (specular) inner surface rather than a diffuse inner surface. Light scattered by the interior of an integrating sphere is evenly distributed over all angles. The total power (radiant flux) of a light source can then be measured without inaccuracy caused by the directional characteristics of the source. Background information on integrating sphere-spectrophotometer apparatus is provided in Liu et al., U.S. Pat. No. 7,532,324 issued on May 12, 2009, the entirety of which hereby is incorporated herein by reference. It is understood throughout this specification that color points may be measured, for example, by utilizing a spectrophotometer, such as an integrating sphere-spectrophotometer. The spectra of reflectance values, absorbance values, and transmittance values of a reflective surface or of an object may be measured, for example, utilizing an ultraviolet-visible-near infrared (UV-VIS-NIR) spectrophotometer.

Throughout this specification, the term “lenticular features” means: an array of semicircular convex lenses (“lenticles”) on a surface, being arranged as a sinusoidal series of mutually parallel ridges between troughs, forming a series of “lenticular toroidal lenses.” Background information on lenticular toroidal lenses and lenticular features is provided in Seo U.S. Pat. No. 8,503,083 issued on Aug. 6, 2013, the entirety of which hereby is incorporated herein by reference.

Throughout this specification, the term “microprismatic features” means an array of small, equally-spaced multi-faceted prisms being arranged in a regular array forming a “microprismatic lens” on a surface. Background information on microprismatic lenses is provided in Pakhchyan U.S. Patent Application Publication No. 2011/0292483A1 published on Dec. 1, 2011, the entirety of which hereby is incorporated herein by reference.

It is understood throughout this specification that numbering of the names of elements as being “first”, “second” etcetera, is solely for purposes of clarity in referring to such elements in connection with various examples of lighting systems. It is understood throughout this specification that an example [100] of a lighting system may include any combination of the features discussed in connection with the examples [100] of a lighting system.

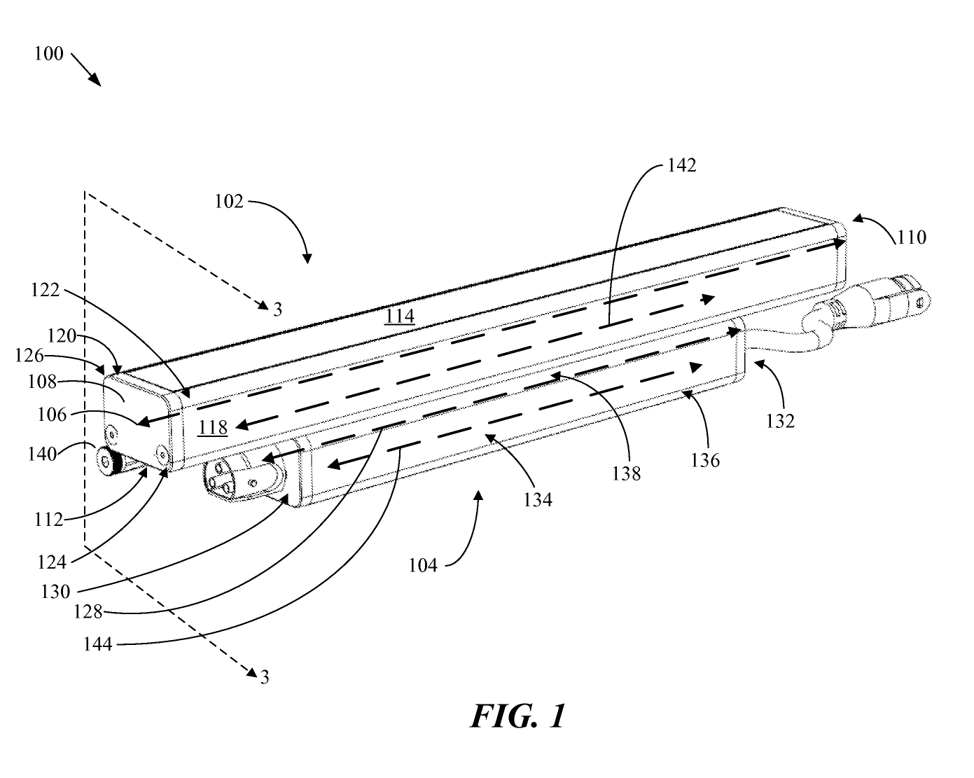

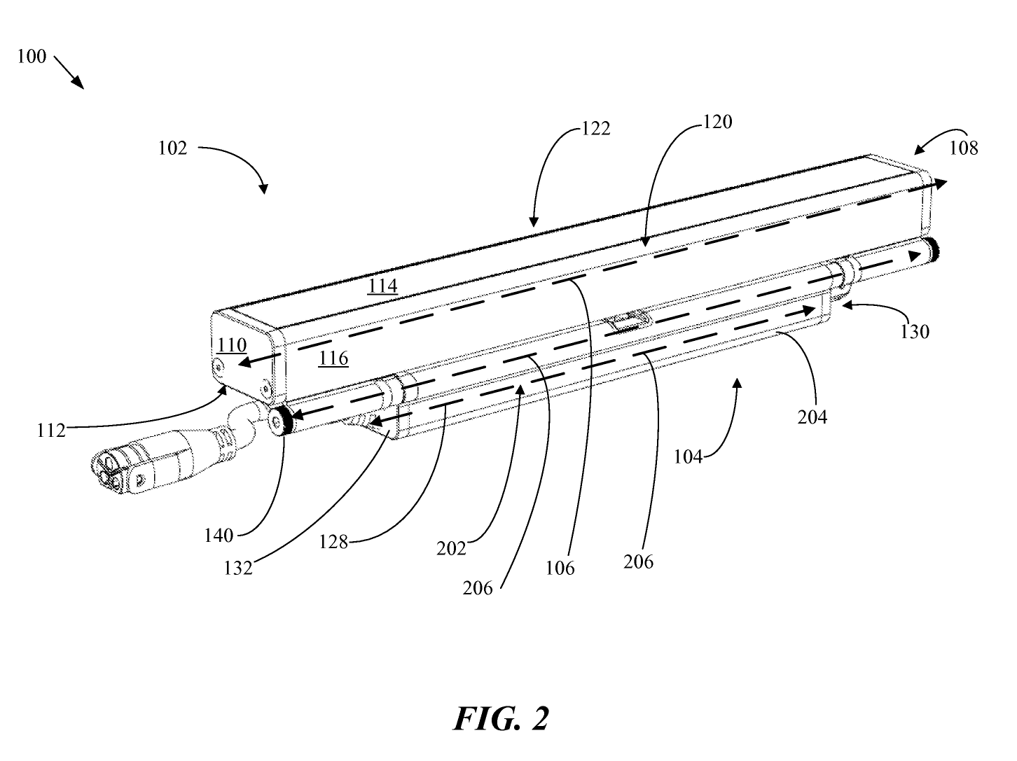

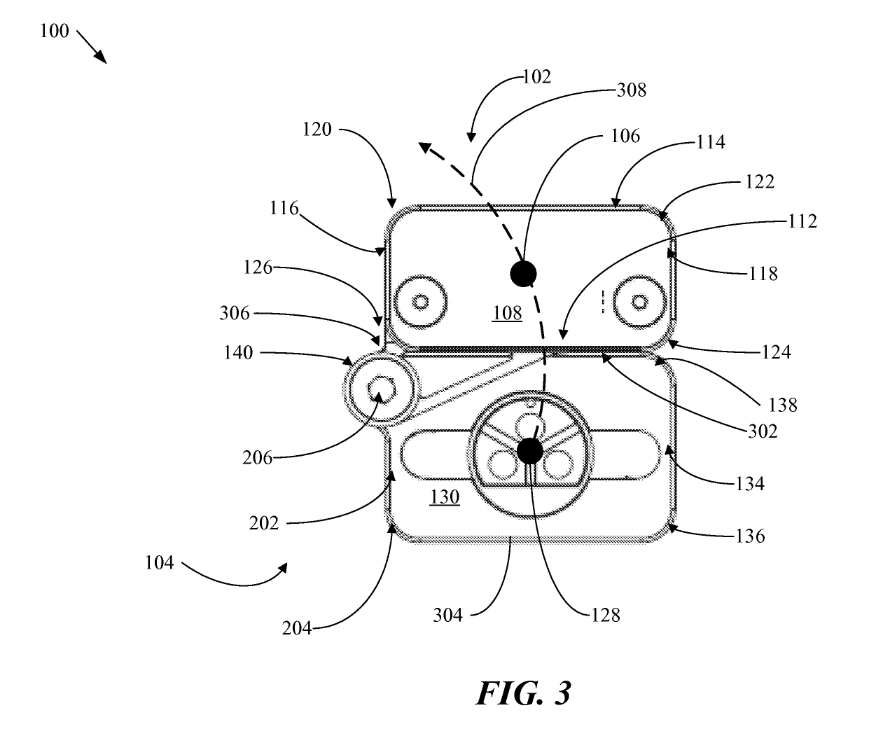

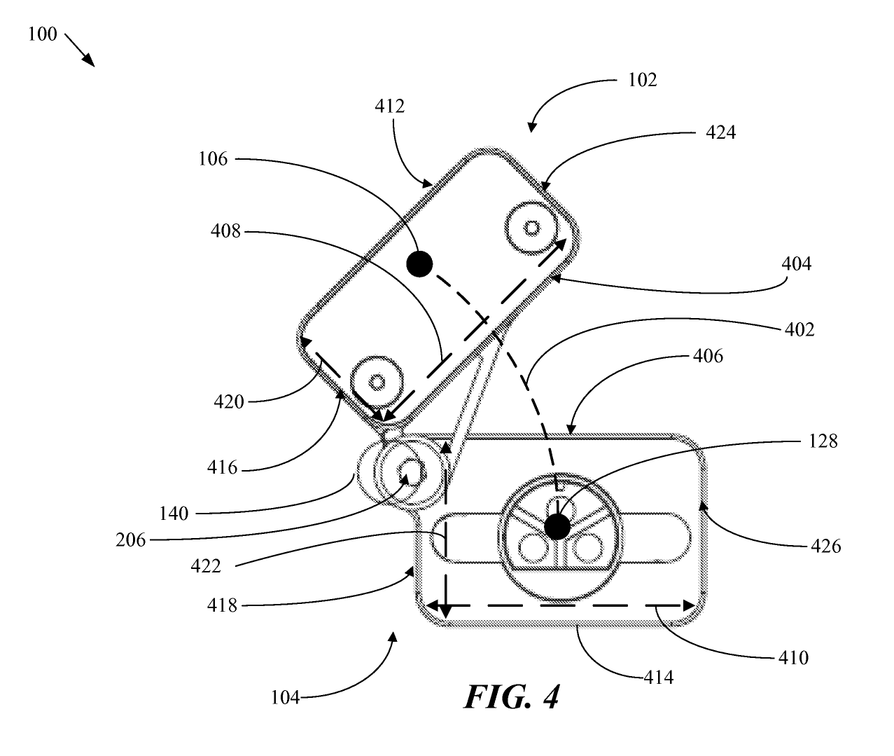

FIG. 1 is a perspective view showing an example [100] of an implementation of a lighting system. FIG. 2 is another perspective view showing the example [100] of an implementation of a lighting system. FIG. 3 is a side view taken along the line 3-3, showing the example [100] of the lighting system. FIG. 4 is another side view of the example [100] of the lighting system shown in FIG. 3. The example [100] of the lighting system includes a first enclosure [102] and a second enclosure [104]. The first enclosure [102] in the example [100] of the lighting system is elongated along a first longitudinal axis [106] and is configured for mounting an array (not shown) of a plurality of lighting modules. The first enclosure [102] of the example [100] of the lighting system includes two opposing end panels [108], [110] being spaced apart along the first longitudinal axis [106]. In the example [100] of the lighting system, the first enclosure [102] also includes a first spaced-apart pair of opposing elongated side panels [112], [114]. The first enclosure [102] of the example [100] of the lighting system further includes a second spaced-apart pair of opposing elongated side panels [116], [118]. In addition, the first enclosure [102] of the example [100] of the lighting system includes four elongated enclosure edges [120], [122], [124], [126] joining together the first pair of the elongated side panels [112], [114] and the second pair of the elongated side panels [116], [118] along the first longitudinal axis [106]. The second enclosure [104] in the example [100] of the lighting system is elongated along a second longitudinal axis [128]. The second enclosure [104] in the example [100] of the lighting system is configured for containing a lighting module power supply (not shown). The second enclosure [104] in the example [100] of the lighting system includes two additional opposing end panels [130], [132] being spaced apart along the second longitudinal axis [128]. The second enclosure [104] in the example [100] of the lighting system also includes a third spaced-apart pair of opposing elongated side panels [302], [304]. The second enclosure [104] in the example [100] of the lighting system further includes a fourth spaced-apart pair of opposing elongated side panels [134], [202]. In addition, the second enclosure [104] in the example [100] of the lighting system includes four additional elongated enclosure edges [136] [138], 204], [306] joining together the third pair of the elongated side panels [302], [304] and the fourth pair of the elongated side panels [134], [202] along the second longitudinal axis [128]. The example [100] of the lighting system additionally includes a pivotable joint assembly [140] having a pivotable joint axis [206]. In the example [100] of the lighting system, the pivotable joint axis [206] is parallel with the first longitudinal axis [106] and the second longitudinal axis [128]. Further, in the example [100] of the lighting system, the pivotable joint assembly [140] is interposed between a one of the elongated enclosure edges [126] and a one of the additional elongated enclosure edges [306]. Additionally, in the example [100] of the lighting system, the pivotable joint assembly [140] is configured for constraining movement of the first longitudinal axis [106] relative to the second longitudinal axis [128], being represented by an arrow [308], as being around and parallel with the pivotable joint axis [206].

FIG. 4 is another side view of an example [100] of the lighting system as shown in FIG. 3, with the first longitudinal axis [106] of the first enclosure [102] having been moved as represented by the arrow [402], away from the second longitudinal axis [128] of the second enclosure [104], partially around and parallel with the pivotable joint axis [206]. In some examples of the example [100] of the lighting system, the pivotable joint assembly [140] may be configured for permitting a one [112] of the first spaced-apart pair of elongated side panels [112], [114] to face towards a one [302] of the third spaced-apart pair of elongated side panels [302], [304]. In further examples of the example [100] of the lighting system, the pivotable joint assembly [140] may be configured for permitting a one [116] of the second spaced-apart pair of elongated side panels [116], [118] to face towards a one [202] of the fourth spaced-apart pair of elongated side panels [134], [202]. In additional examples of the example [100] of the lighting system, configuring the pivotable joint assembly [140] for permitting the one [116] of the second spaced-apart pair of elongated side panels [116], [118] to face towards the one [202] of the fourth spaced-apart pair of elongated side panels [134], [202] may include configuring the pivotable joint assembly [140] for permitting the one [112] of the first spaced-apart pair of elongated side panels [112], [114] to be rotated as represented by the arrow [402] away from the one [302] of the third spaced-apart pair of elongated side panels [302], [304] around the pivotable joint axis by an angle being within a range of between about 0 degrees and about 180 degrees.

In further examples of the example [100] of the lighting system, the one [112] of the first spaced-apart pair of elongated side panels [112], [114] may include a first panel region [404] having a generally flat profile, and the one [302] of the third spaced-apart pair of elongated side panels [302], [304] may include a third panel region [406] having a generally flat profile, and the pivotable joint assembly [140] may be configured for permitting the one [112] of the first spaced-apart pair of elongated side panels [112], [114] to be in direct contact with the one [302] of the third spaced-apart pair of elongated side panels [302], [304]. In other examples of the example [100] of the lighting system, the first panel region [404] may have first dimensions including a first length represented by an arrow [142] along the first longitudinal axis [106], and a first width [408]; and the third panel region [406] may have third dimensions including a third length represented by an arrow [144] along the second longitudinal axis [128], and a third width [410]; and the first width [408] may be substantially the same as the third width [410]. In some examples of the example [100] of the lighting system, another one [114] of the first spaced-apart pair of elongated side panels [112], [114] may include another first panel region [412] having a generally flat profile, and another one [304] of the third spaced-apart pair of elongated side panels [302], [304 may include another third panel region [414] having a generally flat profile.

In further examples of the example [100] of the lighting system, a one [116] of the second spaced-apart pair of elongated side panels [116], [118] may include a second panel region [416] having a generally flat profile, and a one [202] of the fourth spaced-apart pair of elongated side panels [134], [202] may include a fourth panel region [418] having a generally flat profile, and the pivotable joint assembly [140] may be configured for permitting the one [116] of the second spaced-apart pair of elongated side panels [116], [118] to be in direct contact with the one [202] of the fourth spaced-apart pair of elongated side panels [134], [202]. In additional examples of the example [100] of the lighting system, the second panel region [416] may have second dimensions including a second length represented by the arrow [142] along the first longitudinal axis [106], and a second width [420]; and the fourth panel region [418] may have fourth dimensions including a fourth length represented by the arrow [144] along the second longitudinal axis [128], and a fourth width [422]; and the second width [420] may be smaller than the fourth width [422]. In further examples of the example [100] of the lighting system, a combined width being a sum of the second width [420] and the fourth width [422] of the lighting system may be within a range of between about 35 millimeters and about 50 millimeters; or within a range of between about 20 millimeters and about 100 millimeters. In other examples of the example [100] of the lighting system, another one [118] of the second spaced-apart pair of elongated side panels [116], [118] may include another second panel region [424] having a generally flat profile, and another one [134] of the fourth spaced-apart pair of elongated side panels [134], [202] may include another fourth panel region [426] having a generally flat profile. In some examples of the example [100] of the lighting system, configuring the pivotable joint assembly [140] for permitting the one [116] of the second spaced-apart pair of elongated side panels [116], [118] to be in direct contact with the one [202] of the fourth spaced-apart pair of elongated side panels [134], [202] may include configuring the pivotable joint assembly [140] for permitting the one [116] of the second spaced-apart pair of elongated side panels [116], [118] to be rotated toward the one [202] of the fourth spaced-apart pair of elongated side panels [134], [202] around the pivotable joint axis by an angle represented by the arrow [306] being within a range of between about 0 degrees and about 180 degrees.

In further examples of the example [100] of the lighting system, the one [302] of the third spaced-apart pair of elongated side panels [302], [304] may include the third panel region [406] having a generally flat profile, and the second enclosure [104] may be configured for mounting the example [100] of the lighting system by placing the one [302] of the third spaced-apart pair of elongated side panels [302], [304] in contact with a support. In those further examples of the example [100] of the lighting system, the second enclosure [104] may include mounting holes or brackets (not shown) in the one [302] of the third spaced-apart pair of elongated side panels [302], [304]. In additional examples of the example [100] of the lighting system, another one [304] of the third spaced-apart pair of elongated side panels [302], [304] may include the another third panel region [414] having a generally flat profile, and the second enclosure [104] may be configured for mounting the example [100] of the lighting system by placing the another one [304] of the third spaced-apart pair of elongated side panels [302], [304] in contact with a support. In those additional examples of the example [100] of the lighting system, the second enclosure [104] may include mounting holes or brackets (not shown) in the another one [304] of the third spaced-apart pair of elongated side panels [302], [304]. In further examples of the example [100] of the lighting system, the another one [134] of the fourth spaced-apart pair of elongated side panels [134], [202] may include the fourth panel region [426] having a generally flat profile, and the second enclosure [104] may be configured for mounting the example [100] of the lighting system by placing the another one [134] of the fourth spaced-apart pair of elongated side panels [134], [202] in contact with a support. In those further examples of the example [100] of the lighting system, the second enclosure [104] may include mounting holes or brackets (not shown) in the another one [134] of the fourth spaced-apart pair of elongated side panels [134], [202].

In some examples [100] of the lighting system, the second enclosure [104] may be configured for mounting the lighting system by placing a one of the third spaced-apart pair of elongated side panels [302], [304] in contact with a support. In additional examples [100] of the lighting system, the second enclosure [104] may include a mounting hole in the one of the third spaced-apart pair of elongated side panels [302], [304], and the mounting hole may be adapted for receiving a screw or nail for placing the second enclosure [104] in contact with a support. In additional examples [100] of the lighting system, the second enclosure [104] may include a plurality of mounting holes in the one of the third spaced-apart pair of elongated side panels [302], [304], and each of the mounting holes may be adapted for receiving a screw or nail for placing the second enclosure [104] in contact with a support.

In further examples of the example [100] of the lighting system, the one [112] of the first spaced-apart pair of elongated side panels [112], [114] may include the first panel region [404] having a generally flat profile and having first dimensions including a first length represented by the arrow [142] along the first longitudinal axis [106], and a first width represented by the arrow [408]. Also in those further examples of the example [100] of the lighting system, the one [116] of the second spaced-apart pair of elongated side panels [116], [118] may include the second panel region [416] having a generally flat profile and having second dimensions including a second length represented by the arrow [142] along the first longitudinal axis [106], and a second width represented by the arrow [420]. Additionally in those further examples of the example [100] of the lighting system, the second width [420] may be substantially smaller than the first width [408].

In additional examples of the example [100] of the lighting system, the one [302] of the third spaced-apart pair of elongated side panels [302], [304] may include the third panel region [406] having a generally flat profile and having third dimensions including a third length represented by the arrow [144] along the second longitudinal axis [128], and a third width represented by the arrow [410]. Also in those additional examples of the example [100] of the lighting system, the one [202] of the fourth spaced-apart pair of elongated side panels [134], [202] may include the fourth panel region [418] having a generally flat profile and having fourth dimensions including a fourth length represented by the arrow [144] along the second longitudinal axis [128], and a fourth width represented by the arrow [422]. Further in those additional examples of the example [100] of the lighting system, the fourth width [422] may be substantially smaller than the second width [420].

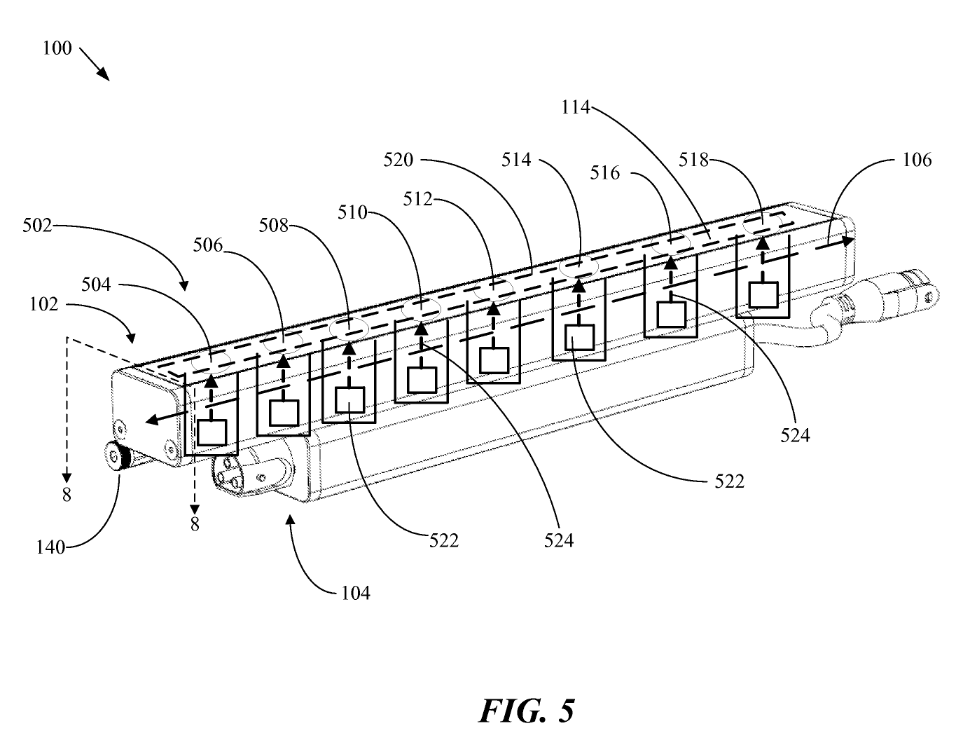

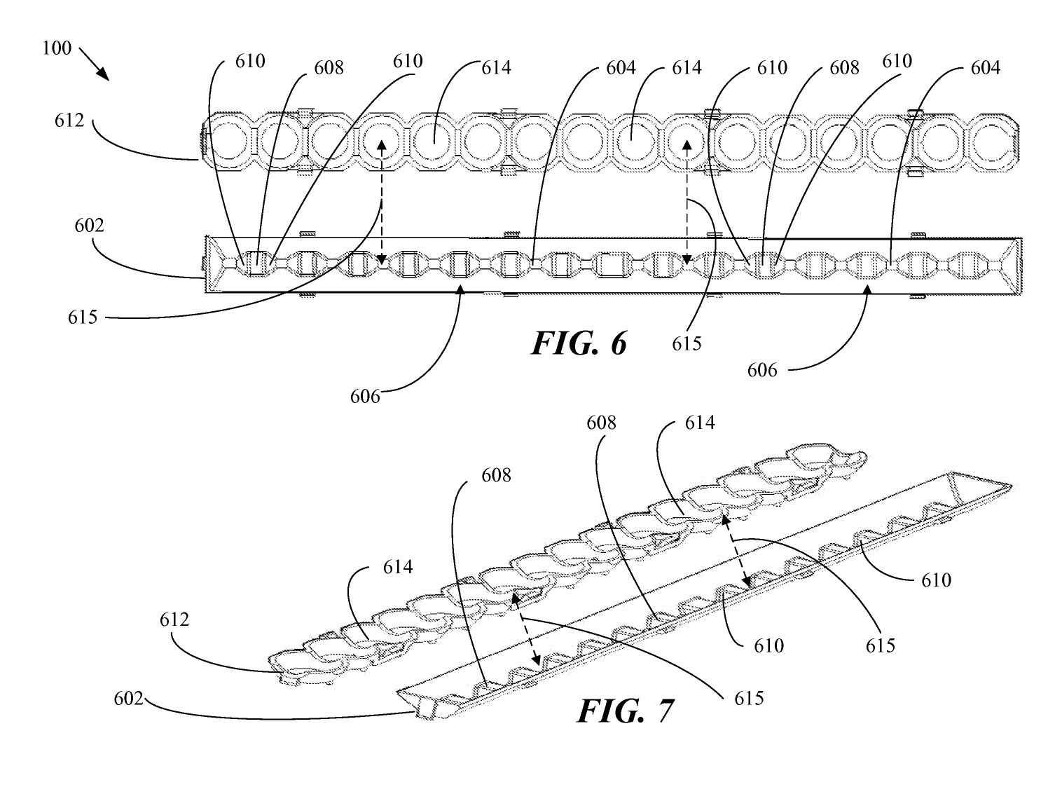

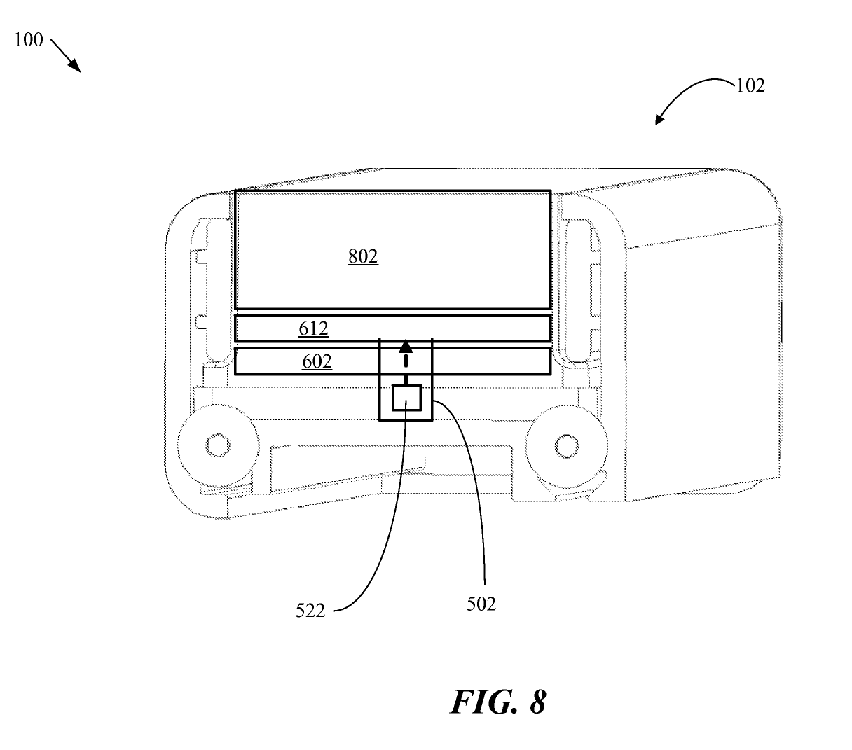

FIG. 5 is another perspective view showing the example [100] of an implementation of a lighting system. FIG. 6 is a top view showing examples of the carrier and the primary visible light reflector that may be included in the example [100] of an implementation of a lighting system. FIG. 7 is a perspective view showing the examples of the carrier and the primary visible light reflector as shown in FIG. 6. FIG. 8 is a cross-sectional view taken on line 8-8, of the example [100] of the lighting system as shown in FIG. 5. In some examples, the example [100] of the lighting system may include an array [502] of a plurality of lighting modules [504], [506], [508], [510], [512], [514], [516], [518] being mounted in the first enclosure [102], wherein the pivotable joint assembly [140] is configured for permitting a one [112] of the first spaced-apart pair of elongated side panels [112], [114] to face towards a one [302] of the third spaced-apart pair of elongated side panels [302], [304], and the first enclosure [102] may be configured for mounting the array [502] of the plurality of lighting modules [504], [506], [508], [510], [512], [514], [516], [518] for emitting light emissions through the another one [114] of the first spaced-apart pair of elongated side panels [112], [114]. In some examples [100] of the lighting system, the another one [114] of the first spaced-apart pair of elongated side panels [112], [114] may include a first transparent panel region [520], being transparent to visible light, and having a generally flat profile. In additional examples [100] of the lighting system, each one of the plurality of the lighting modules [504], [506], [508], [510], [512], [514], [516], [518] may include a semiconductor light-emitting device [522]. In other examples [100] of the lighting system, each one of the plurality of the lighting modules [504], [506], [508], [510], [512], [514], [516], [518] may have a central light emission axis [524], and each one of the plurality of the lighting modules [504], [506], [508], [510], [512], [514], [516], [518] may be configured for emitting light emissions along the respective central light emission axis [524] of the lighting module [504], [506], [508], [510], [512], [514], [516], [518]. In some examples [100] of the lighting system, the first enclosure [102] may include a primary visible light reflector [602] having a plurality of reflector apertures [604], the plurality of the reflector apertures [604] being spaced apart along the first longitudinal axis [106] and being aligned as represented by arrows [615] with the central light emission axes [524] of the lighting modules [504], [506], [508], [510], [512], [514], [516], [518]. In some examples [100] of the lighting system, the primary visible light reflector [602] may include the plurality of the reflector apertures [604] as being spaced apart in a row along the first longitudinal axis [106]. In further examples [100] of the lighting system, the primary visible light reflector [602] may include the plurality of the reflector apertures [604] as being spaced apart in a plurality of rows along the first longitudinal axis [106]. In additional examples [100] of the lighting system, the primary visible light reflector [602] may include a plurality of reflector elements [606], and each of the reflector elements [606] may include a top reflective surface [608] being located between two tangential reflective surfaces [610], and each of the reflector apertures [604] of the primary visible light reflector [602] may be located between a pair of the reflector elements [606]. In other examples [100] of the lighting system, the first elongated enclosure [102] may include a carrier [612] having a plurality of carrier apertures [614], the plurality of the carrier apertures [614] being spaced apart along the first longitudinal axis [106] and being aligned as represented by the arrows [615] with the central light emission axes [524] of the lighting modules [504], [506], [508], [510], [512], [514], [516], [518], each one of the plurality of the carrier apertures [614] of the carrier [612] being configured and shaped for receiving and mounting a lens module [802]. Suitable lighting modules and lens modules for incorporation into the examples [100] of the lighting system are disclosed in the commonly-owned U.S. patent application Ser. No. ______, being filed on the same date herewith, entitled “Lighting Systems Including Lens Modules For Selectable Light Distribution,” the entirety of which is hereby incorporated herein by reference.

In other examples [100] (not shown), the lighting system may have an array [502] of a plurality of lighting modules [504], [506], [508], [510], [512], [514], [516], [518] being mounted in the first enclosure [102]. In those other examples [100] of the lighting system, the pivotable joint assembly [140] may be configured for permitting the one [112] of the first spaced-apart pair of elongated side panels [112], [114] to face towards the one [302] of the third spaced-apart pair of elongated side panels [302], [304]. Further in those other examples [100] of the lighting system, the first enclosure [102] may be configured for mounting the array [502] of the plurality of lighting modules [504], [506], [508], [510], [512], [514], [516], [518] for emitting light emissions through the one [118] of the second spaced-apart pair of elongated side panels [116], [118].

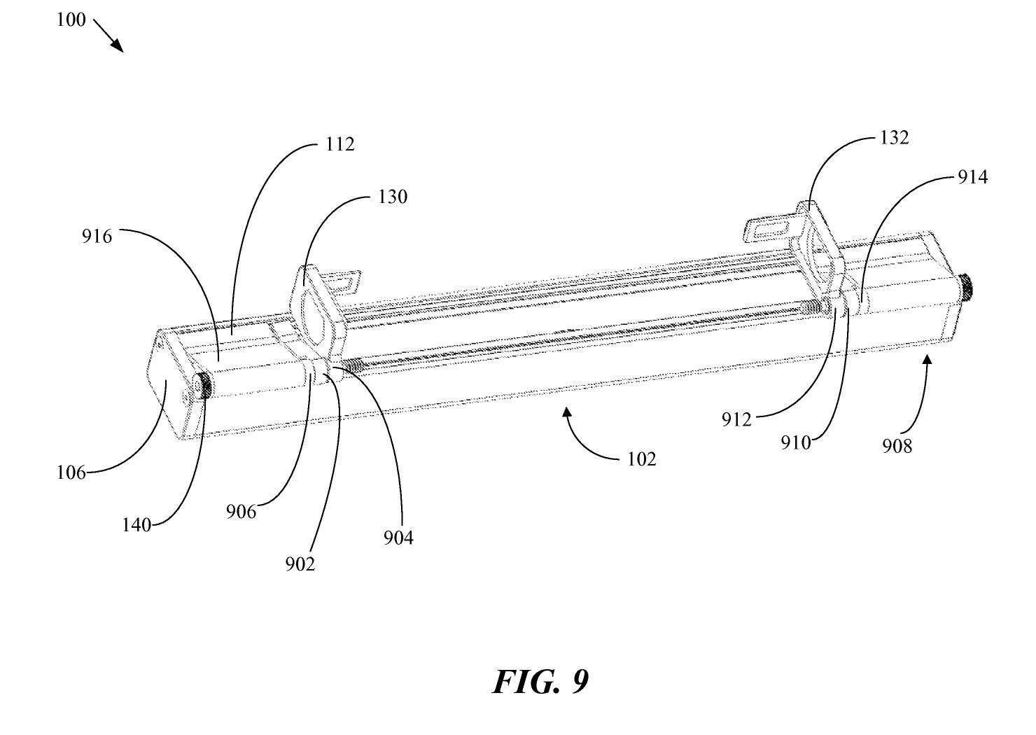

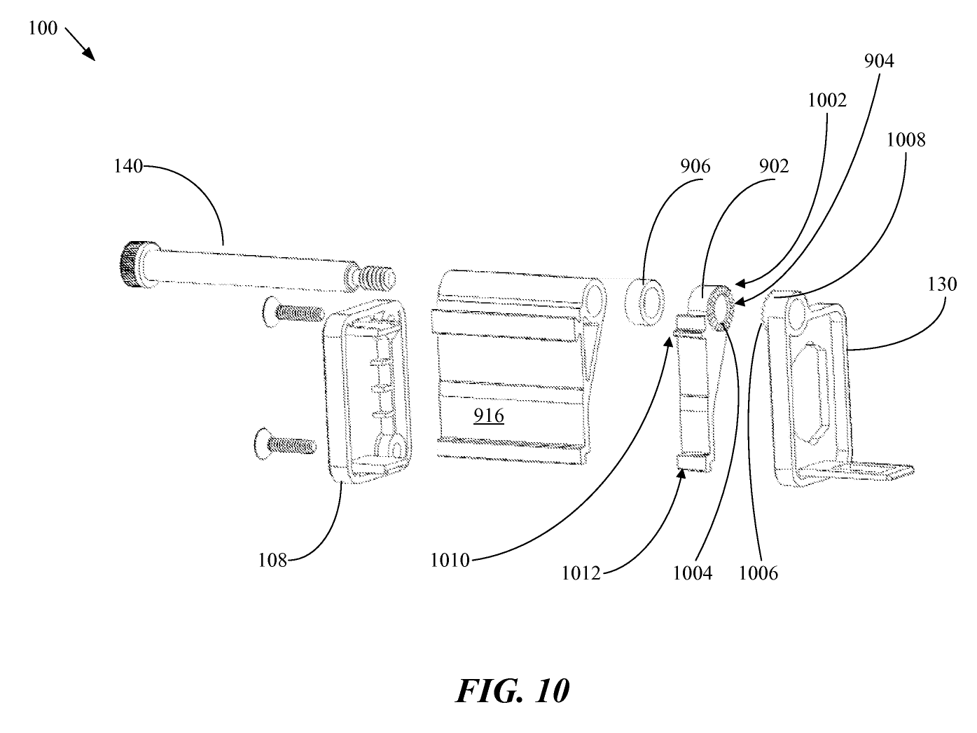

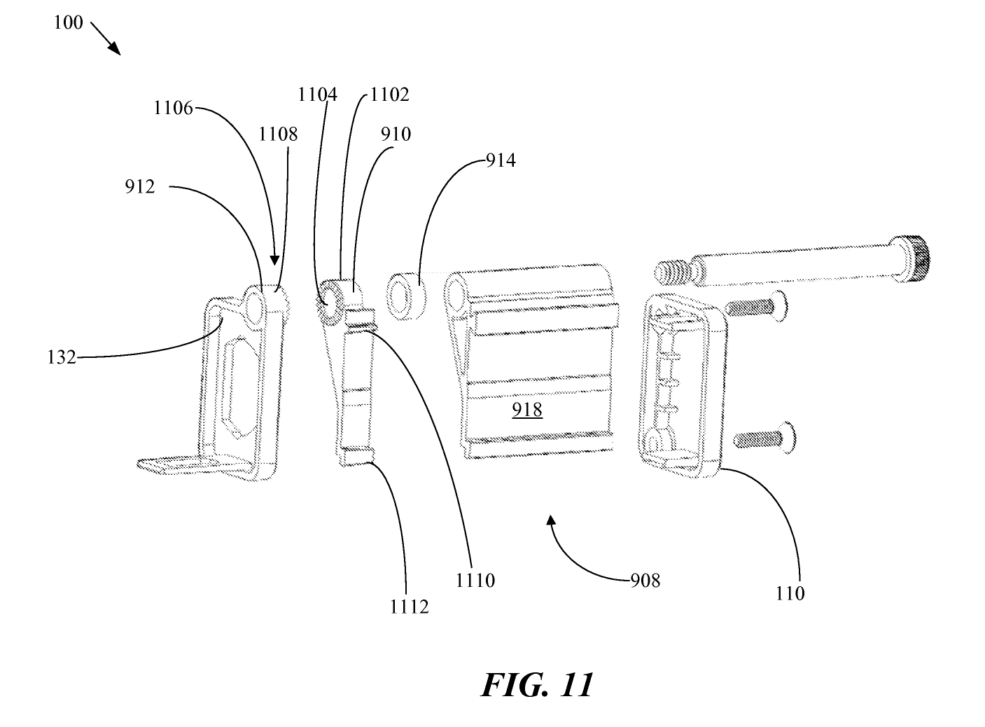

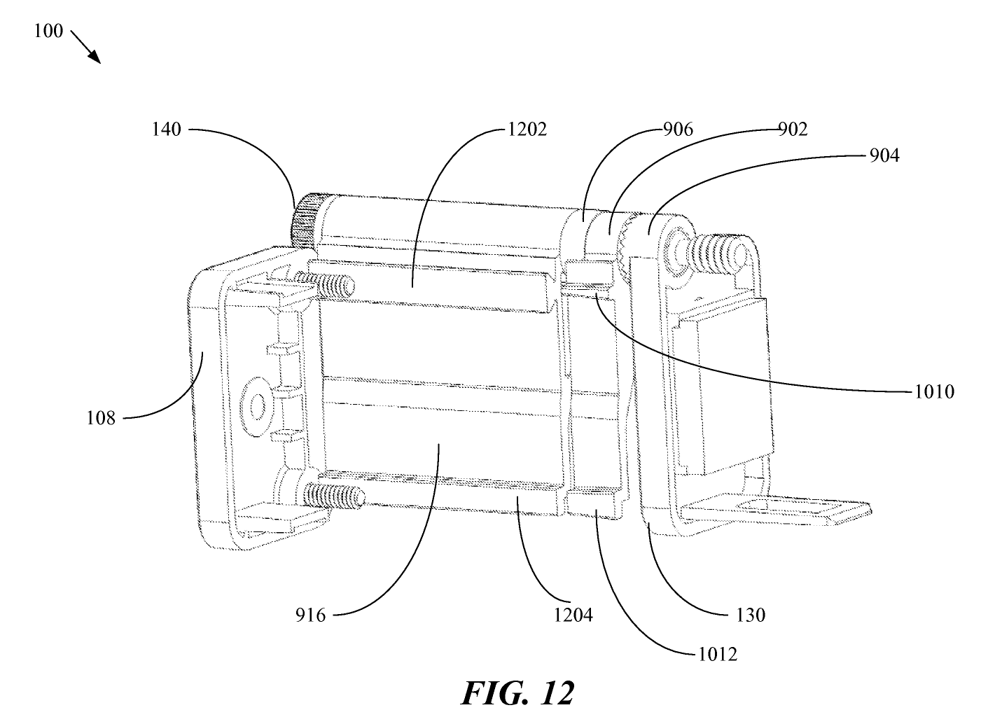

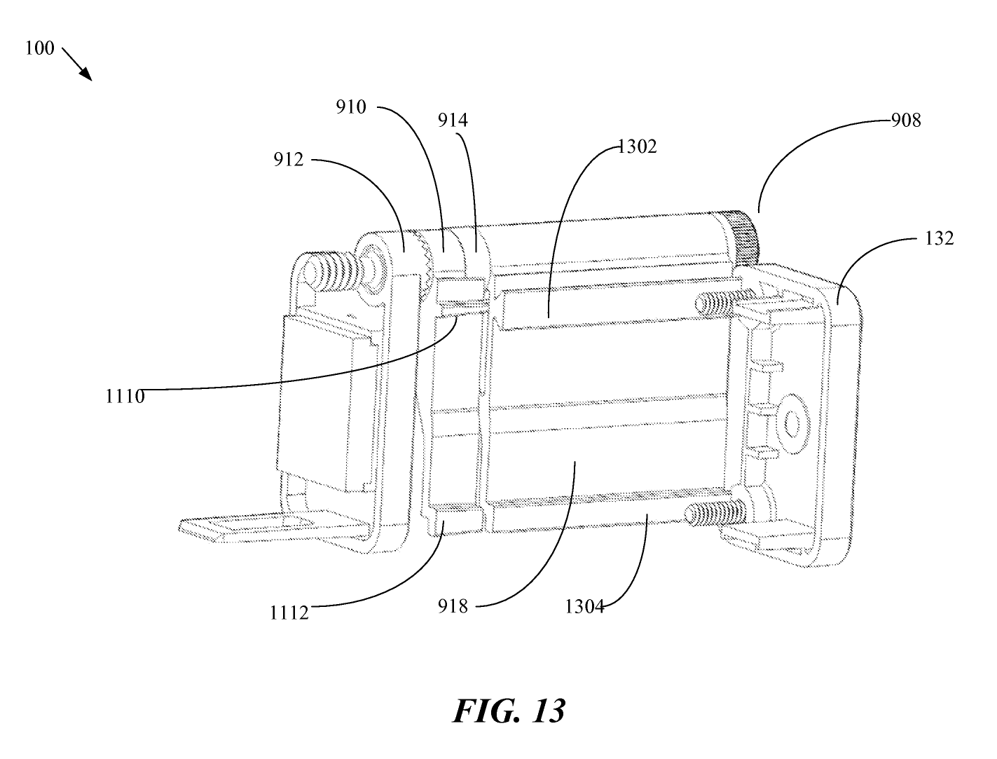

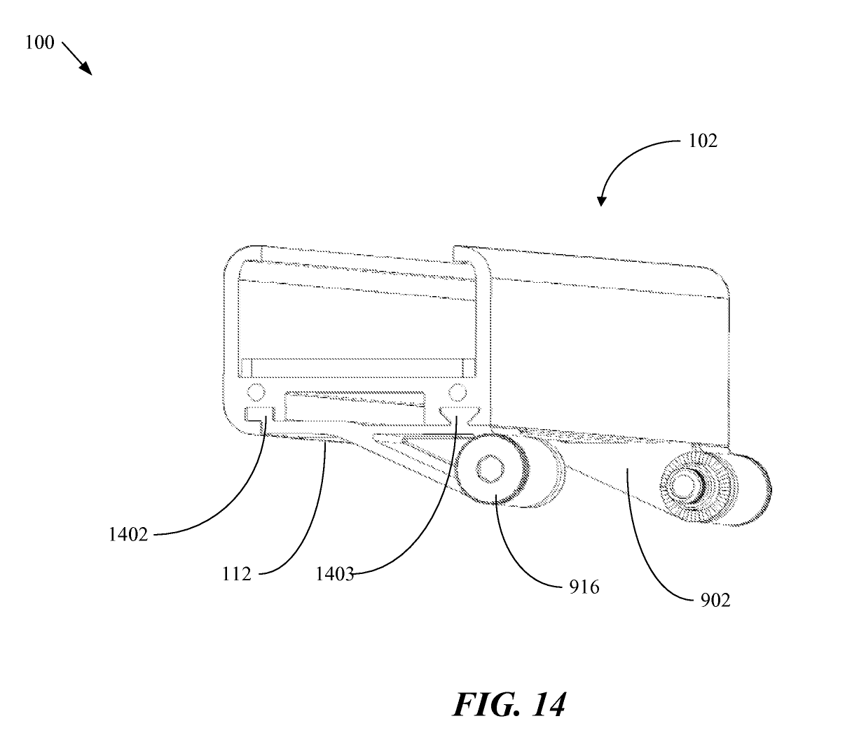

FIG. 9 is a perspective view showing a portion of an example [100] of the lighting system. FIG. 10 is another perspective view showing a portion of an example [100] of the lighting system. FIG. 11 is a further perspective view showing a portion of an example [100] of the lighting system. FIG. 12 is an additional perspective view showing a portion of an example [100] of the lighting system. FIG. 13 is another perspective view showing a portion of an example [100] of the lighting system. FIG. 14 is another perspective view showing a portion of an example [100] of the lighting system. In some examples [100] of the lighting system, the pivotable joint assembly [140] may include a first pivot joint element [902] being attached to the first enclosure [102], and a second pivot joint element [904] being attached to the second enclosure [104]. In those examples [100] of the lighting system, the first pivot joint element [902] and the second pivot joint element [904] may be configured for cooperatively securing the one [112] of the first spaced-apart pair of elongated side panels [112], [114] at a position represented by the arrow [306] being located away from the one [302] of the third spaced-apart pair of elongated side panels [302], [304] by an angle around the pivotable joint axis. Further in those examples [100] of the lighting system, the one [112] of the first spaced-apart pair of elongated side panels [112], [114] may be secured at a position being located away from the one [302] of the third spaced-apart pair of elongated side panels [302], [304] around the pivotable joint axis [206] by an angle being within the range of between about 0 degrees and about 180 degrees.

In some examples [100] of the lighting system, the first pivot joint element [902] may include a first circular disc [1002] having a first flat side [1004] with raised features, and the second pivot joint element [904] may include a second circular disc [1006] having a second flat side [1008] with raised features, and the pivotable joint assembly [140] may be configured for placing the first flat side [1004] of the first circular disc [1002] in direct contact with the second flat side [1008] of the second circular disc [1006]. In further examples [100] of the lighting system, the raised features of the first and second flat sides [1004], [1008] of the first and second circular discs [1002], [1006] may each include a circular pattern of alternating radially extending crests and valleys having a uniform contour. In additional examples [100] of the lighting system, the pivotable joint assembly [140] may include a spring [906] being configured for biasing the first flat side [1004] of the first circular disc [1002] as being in direct contact with the second flat side [1008] of the second circular disc [1006].

In other examples [100] of the lighting system, first pivot joint element [902] may include a first circular clutch plate (not shown), and the second pivot joint element [904] may include a second circular clutch plate (not shown), and the pivotable joint assembly [140] may be configured for placing the first clutch plate in direct contact with the second clutch plate. Further in those other examples [100] of the lighting system, (not shown), the first clutch plate may include first frictional pad, and the second clutch plate may include a second frictional pad, and the pivotable joint assembly [140] may be configured for placing the first frictional pad in direct contact with the second frictional pad.

In some examples [100], the lighting system may include another pivotable joint assembly [908] that may include a third pivot joint element [910] being attached to the first enclosure [102] and that may include a fourth pivot joint element [912] being attached to the second enclosure [104]. In those examples [100] of the lighting system, the third and fourth pivot joint elements [910], [912] may be configured for cooperatively securing the one [112] of the first spaced-apart pair of elongated side panels [112], [114] at a position being located away from the one [302] of the third spaced-apart pair of elongated side panels [302], [304] around the pivotable joint axis by an angle around the pivotable joint axis. Further in those examples [100] of the lighting system, the one [112] of the first spaced-apart pair of elongated side panels [112], [114] may be secured at a position being located away from the one [302] of the third spaced-apart pair of elongated side panels [302], [304] around the pivotable joint axis [206] by an angle being within the range of between about 0 degrees and about 180 degrees.

In further examples [100] of the lighting system, third pivot joint element [910] may include a third circular disc [1102] having a third flat side [1104] with raised features, and the fourth pivot joint element [912] may include a fourth circular disc [1106] having a fourth flat side [1108] with raised features, and the another pivotable joint assembly [908] may be configured for placing the third flat side [1104] of the third circular disc [1102] in direct contact with the fourth flat side [1108] of the fourth circular disc [1106]. In some examples [100] of the lighting system, the raised features of the third and fourth flat sides [1104], [1108] of the third and fourth circular discs [1102], [1106] may each include a circular pattern of alternating radially extending crests and valleys having a uniform contour. In further examples [100] of the lighting system, the another pivotable joint assembly [908] may include another spring [914] being configured for biasing the third flat side [1104] of the third circular disc [1102] as being in direct contact with the fourth flat side [1108] of the fourth circular disc [1106].

In some examples [100] of the lighting system, the second pivot joint element [904] may be attached to the end panel [130] of the second enclosure [104], and the fourth pivot joint element [912] may be attached to the another one of the end panels [132] of the second enclosure [104]. In further examples [100] of the lighting system, each of the first and third pivot joint elements [902], 910] may be attached to the one [112] of the first spaced-apart pair of elongated side panels [112], [114].

In additional examples [100] of the lighting system, the one [112] of the first spaced-apart pair of elongated side panels [112], [114] may include a support plate [916] attached to the pivotable joint assembly [140]; and may include another support plate [918] attached to the another pivotable joint assembly [908]. In some examples [100] of the lighting system, the support plate [916] may include a raised rib [1202] being spaced apart from a raised lip [1204], being configured for attaching the support plate [916] to the one [112] of the first spaced-apart pair of elongated side panels [112], [114]. In further examples [100] of the lighting system, the support plate [918] may include a raised rib [1302] being spaced apart from a raised lip [1304], being configured for attaching the support plate [918] to the one [112] of the first spaced-apart pair of elongated side panels [112], [114]. Additionally in those examples [100] of the lighting system, the one [112] of the first spaced-apart pair of elongated side panels [112], [114] may include two spaced-apart tracks [1402], [1403] configured for receiving the raised rib [1202] and the raised lip [1204]; and two spaced-apart tracks (not shown) configured for receiving the raised rib [1302] and the raised lip [1304]. In other examples [100] of the lighting system, the first pivot joint element [902] may include a raised rib [1010] being spaced apart from a raised lip [1012], being configured for attaching the first pivot joint element [902] to the one [112] of the first spaced-apart pair of elongated side panels [112], [114]. In additional examples [100] of the lighting system, the third pivot joint element [910] may include a raised rib [1110] being spaced apart from a raised lip [1112], being configured for attaching the third pivot joint element [910] to the one [112] of the first spaced-apart pair of elongated side panels [112], [114].

The examples [100] of lighting systems may generally be utilized in end-use applications where an array of lighting modules are needed, enabling a lighting system to be easily and repeatedly adjusted in order to direct light emissions in a range of directions.

While the present invention has been disclosed in a presently defined context, it will be recognized that the present teachings may be adapted to a variety of contexts consistent with this disclosure and the claims that follow. For example, the lighting systems shown in the figures and discussed above can be adapted in the spirit of the many optional parameters described.

What is claimed is:

1. A lighting system, comprising:
a first enclosure being elongated along a first longitudinal axis and being configured for mounting an array of a plurality of lighting modules, the first enclosure including: two opposing end panels being spaced apart along the first longitudinal axis; a first spaced-apart pair of opposing elongated side panels; a second spaced-apart pair of opposing elongated side panels; and four elongated enclosure edges joining together the first and second pairs of the elongated side panels along the first longitudinal axis;
a second enclosure being elongated along a second longitudinal axis and being configured for containing a lighting module power supply, the second enclosure including: two additional opposing end panels being spaced apart along the second longitudinal axis; a third spaced-apart pair of opposing elongated side panels; a fourth spaced-apart pair of opposing elongated side panels; and four additional elongated enclosure edges joining together the third and fourth pairs of the elongated side panels along the second longitudinal axis;
a pivotable joint assembly having a pivotable joint axis, the pivotable joint axis being parallel with the first and second longitudinal axes, the pivotable joint assembly being interposed between a one of the elongated enclosure edges and a one of the additional elongated enclosure edges and being configured for constraining movement of the first longitudinal axis relative to the second longitudinal axis as being around and parallel with the pivotable joint axis.

2. The lighting system of claim 1, wherein the pivotable joint assembly is configured for permitting a one of the first spaced-apart pair of elongated side panels to face towards a one of the third spaced-apart pair of elongated side panels.

3. The lighting system of claim 2, wherein the pivotable joint assembly is configured for permitting a one of the second spaced-apart pair of elongated side panels to face towards a one of the fourth spaced-apart pair of elongated side panels.

4. The lighting system of claim 3, wherein configuring the pivotable joint assembly for permitting the one of the second spaced-apart pair of elongated side panels to face towards the one of the fourth spaced-apart pair of elongated side panels includes configuring the pivotable joint assembly for permitting the one of the first spaced-apart pair of elongated side panels to be rotated away from the one of the third spaced-apart pair of elongated side panels around the pivotable joint axis by an angle being within a range of between about 0 degrees and about 180 degrees.

5. The lighting system of claim 2, wherein the one of the first spaced-apart pair of elongated side panels includes a first panel region having a generally flat profile, and wherein the one of the third spaced-apart pair of elongated side panels includes a third panel region having a generally flat profile, and wherein the pivotable joint assembly is configured for permitting the one of the first spaced-apart pair of elongated side panels to be in direct contact with the one of the third spaced-apart pair of elongated side panels.

6. The lighting system of claim 5, wherein the first panel region has first dimensions including a first length along the first longitudinal axis, and a first width; and wherein the third panel region has third dimensions including a third length along the second longitudinal axis, and a third width; and wherein the first width is substantially the same as the third width.

7. The lighting system of claim 5, wherein another one of the first spaced-apart pair of elongated side panels includes another first panel region having a generally flat profile, and wherein another one of the third spaced-apart pair of elongated side panels includes another third panel region having a generally flat profile.

8. The lighting system of claim 5, wherein a one of the second spaced-apart pair of elongated side panels includes a second panel region having a generally flat profile, and wherein a one of the fourth spaced-apart pair of elongated side panels includes a fourth panel region having a generally flat profile, and wherein the pivotable joint assembly is configured for permitting the one of the second spaced-apart pair of elongated side panels to be in direct contact with the one of the fourth spaced-apart pair of elongated side panels.

9. The lighting system of claim 8, wherein the second panel region has second dimensions including a second length along the first longitudinal axis, and a second width; and wherein the fourth panel region has fourth dimensions including a fourth length along the second longitudinal axis, and a fourth width; and wherein the second width is smaller than the fourth width.

10. The lighting system of claim 9, wherein a combined width, being a sum of the second and fourth widths of the lighting system, is within a range of between about 35 millimeters and about 50 millimeters.

11. The lighting system of claim 8, wherein another one of the second spaced-apart pair of elongated side panels includes another second panel region having a generally flat profile, and wherein another one of the fourth spaced-apart pair of elongated side panels includes another fourth panel region having a generally flat profile.

12. The lighting system of claim 8, wherein configuring the pivotable joint assembly for permitting the one of the second spaced-apart pair of elongated side panels to be in direct contact with the one of the fourth spaced-apart pair of elongated side panels includes configuring the pivotable joint assembly for permitting the one of the second spaced-apart pair of elongated side panels to be rotated toward the one of the fourth spaced-apart pair of elongated side panels around the pivotable joint axis by an angle being within a range of between about 0 degrees and about 180 degrees.

13. The lighting system of claim 2, wherein the one of the third spaced-apart pair of elongated side panels includes a third panel region having a generally flat profile, and wherein the second enclosure is configured for mounting the lighting system by placing the one of the third spaced-apart pair of elongated side panels in contact with a support.

14. The lighting system of claim 13, wherein another one of the third spaced-apart pair of elongated side panels includes another third panel region having a generally flat profile, and wherein the second enclosure is configured for mounting the lighting system by placing the another one of the third spaced-apart pair of elongated side panels in contact with a support.

15. The lighting system of claim 1, wherein a one of the fourth spaced-apart pair of elongated side panels includes a fourth panel region having a generally flat profile, and wherein the second enclosure is configured for mounting the lighting system by placing the one of the fourth spaced-apart pair of elongated side panels in contact with a support.

16. The lighting system of claim 1, wherein a one of the first spaced-apart pair of elongated side panels includes a first panel region having a generally flat profile having first dimensions including a first length along the first longitudinal axis, and a first width; and wherein a one of the second spaced-apart pair of elongated side panels includes a second panel region having a generally flat profile having second dimensions including a second length along the first longitudinal axis, and a second width; and wherein the second width is substantially smaller than the first width.

17. The lighting system of claim 1, wherein a one of the third spaced-apart pair of elongated side panels includes a third panel region having a generally flat profile having third dimensions including a third length along the second longitudinal axis, and a third width; and wherein a one of the fourth spaced-apart pair of elongated side panels includes a fourth panel region having a generally flat profile having fourth dimensions including a fourth length along the second longitudinal axis, and a fourth width; and wherein the fourth width is substantially smaller than the second width.

18. The lighting system of claim 1 further having an array of a plurality of lighting modules being mounted in the first enclosure, wherein the pivotable joint assembly is configured for permitting a one of the first spaced-apart pair of elongated side panels to face towards a one of the third spaced-apart pair of elongated side panels, and wherein the first enclosure is configured for mounting the array of the plurality of lighting modules for emitting light emissions through another one of the first spaced-apart pair of elongated side panels.

19. The lighting system of claim 18, wherein the another one of the first spaced-apart pair of elongated side panels includes a first transparent panel region having a generally flat profile.

20. The lighting system of claim 18, wherein each one of the plurality of the lighting modules includes a semiconductor light-emitting device.

21. The lighting system of claim 20, wherein each one of the plurality of the lighting modules has a central light emission axis, and wherein each one of the plurality of the lighting modules is configured for emitting light emissions along the central light emission axis of the lighting module.

22. The lighting system of claim 21, wherein the first enclosure includes a primary visible light reflector having a plurality of reflector apertures, the plurality of the reflector apertures being spaced apart along the first longitudinal axis and being aligned with the central light emission axes of the lighting modules.

23. The lighting system of claim 22, wherein the primary visible light reflector includes the plurality of the reflector apertures as being spaced apart in a row along the first longitudinal axis.

24. The lighting system of claim 22, wherein the primary visible light reflector includes the plurality of the reflector apertures as being spaced apart in a plurality of rows along the first longitudinal axis.

25. The lighting system of claim 22, wherein the primary visible light reflector includes a plurality of reflector elements, and wherein each of the reflector elements includes a top reflective surface being located between two tangential reflective surfaces, and wherein each of the reflector apertures of the primary visible light reflector is located between a pair of the reflector elements.

26. The lighting system of claim 22, wherein the first enclosure includes a carrier having a plurality of carrier apertures, the plurality of the carrier apertures being spaced apart along the first longitudinal axis and being aligned with the central light emission axes of the lighting modules, each one of the plurality of the carrier apertures of the carrier being configured and shaped for receiving and mounting a lens module.

27. The lighting system of claim 1 further having an array of a plurality of lighting modules being mounted in the first enclosure, wherein the pivotable joint assembly is configured for permitting a one of the first spaced-apart pair of elongated side panels to face towards a one of the third spaced-apart pair of elongated side panels, and wherein the first enclosure is configured for mounting the array of the plurality of lighting modules for emitting light emissions through a one of the second spaced-apart pair of elongated side panels.

28. The lighting system of claim 4, wherein the pivotable joint assembly includes a first pivot joint element being attached to the first enclosure and a second pivot joint element being attached to the second enclosure, and wherein the first and second pivot joint elements are configured for cooperatively securing the one of the first spaced-apart pair of elongated side panels at a position being located away from the one of the third spaced-apart pair of elongated side panels around the pivotable joint axis by an angle being within the range of between about 0 degrees and about 180 degrees.

29. The lighting system of claim 2, wherein the pivotable joint assembly includes a first pivot joint element being attached to the first enclosure and a second pivot joint element being attached to the second enclosure, and wherein the first and second pivot joint elements are configured for cooperatively securing the one of the first spaced-apart pair of elongated side panels at a position being located away from the one of the third spaced-apart pair of elongated side panels by an angle around the pivotable joint axis.

30. The lighting system of claim 29, wherein the first pivot joint element includes a first circular disc having a first flat side with raised features, and wherein the second pivot joint element includes a second circular disc having a second flat side with raised features, and wherein the pivotable joint assembly is configured for placing the first flat side of the first circular disc in direct contact with the second flat side of the second circular disc.

31. The lighting system of claim 30, wherein the raised features of the first and second flat sides of the first and second circular discs each include a circular pattern of alternating radially extending crests and valleys having a uniform contour.

32. The lighting system of claim 30, wherein the pivotable joint assembly includes a spring being configured for biasing the first flat side of the first circular disc as being in direct contact with the second flat side of the second circular disc.

33. The lighting system of claim 29, wherein the first pivot joint element includes a first circular clutch plate, and wherein the second pivot joint element includes a second circular clutch plate, and wherein the pivotable joint assembly is configured for placing the first clutch plate in direct contact with the second clutch plate.

34. The lighting system of claim 33, wherein the first clutch plate includes a first frictional pad, and wherein the second clutch plate includes a second frictional pad, and wherein the pivotable joint assembly is configured for placing the first frictional pad in direct contact with the second frictional pad.

35. The lighting system of claim 4, including another pivotable joint assembly that includes a third pivot joint element being attached to the first enclosure and a fourth pivot joint element being attached to the second enclosure, and wherein the third and fourth pivot joint elements are configured for cooperatively securing the one of the first spaced-apart pair of elongated side panels at a position being located away from the one of the third spaced-apart pair of elongated side panels around the pivotable joint axis by an angle within the range of between about 0 degrees and about 180 degrees.

36. The lighting system of claim 29, including another pivotable joint assembly that includes a third pivot joint element being attached to the first enclosure and a fourth pivot joint element being attached to the second enclosure, and wherein the third and fourth pivot joint elements are configured for cooperatively securing the one of the first spaced-apart pair of elongated side panels at a position being located away from the one of the third spaced-apart pair of elongated side panels by an angle around the pivotable joint axis.

37. The lighting system of claim 36, wherein the third pivot joint element includes a third circular disc having a third flat side with raised features, and wherein the fourth pivot joint element includes a fourth circular disc having a fourth flat side with raised features, and wherein the another pivotable joint assembly is configured for placing the third flat side of the third circular disc in direct contact with the fourth flat side of the fourth circular disc.

38. The lighting system of claim 37, wherein the raised features of the third and fourth flat sides of the third and fourth circular discs each include a circular pattern of alternating radially extending crests and valleys having a uniform contour.

39. The lighting system of claim 37, wherein the another pivotable joint assembly includes another spring being configured for biasing the third flat side of the third circular disc as being in direct contact with the fourth flat side of the fourth circular disc.

40. The lighting system of claim 36, wherein the second pivot joint element is attached to one of the end panels of the second enclosure, and wherein the fourth pivot joint element is attached to another one of the end panels of the second enclosure.

41. The lighting system of claim 40, wherein each of the first and third pivot joint elements is attached to the one of the first spaced-apart pair of elongated side panels.

42. The lighting system of claim 41, wherein the one of the first spaced-apart pair of elongated side panels includes: a support plate attached to the pivotable joint assembly; and another support plate attached to the another pivotable joint assembly.

43. The lighting system of claim 42, wherein each of the support plates includes a raised rib being spaced apart from a raised lip, being configured for attaching the support plates to the one of the first spaced-apart pair of elongated side panels; and wherein the one of the first spaced-apart pair of elongated side panels includes two spaced-apart tracks configured for receiving the raised ribs and the raised lips.

44. The lighting system of claim 43, wherein each of the pivot joint elements includes a raised rib being spaced apart from a raised lip, being configured for attaching the pivot joint elements to the one of the first spaced-apart pair of elongated side panels.

45. The lighting system of claim 1, wherein the second enclosure is configured for mounting the lighting system by placing a one of the third spaced-apart pair of elongated side panels in contact with a support.

46. The lighting system of claim 45, wherein the second enclosure includes a mounting hole in the one of the third spaced-apart pair of elongated side panels, and wherein the mounting hole is adapted for receiving a screw or nail for placing the second enclosure in contact with a support.

47. The lighting system of claim 45, wherein the second enclosure includes a plurality of mounting holes in the one of the third spaced-apart pair of elongated side panels, and wherein each of the mounting holes is adapted for receiving a screw or nail for placing the second enclosure in contact with a support.
